(19) United States
(12) Patent Application Publication
(10) Pub. No.: US 2026/0234809 A1
(43) Pub. Date: Aug. 13, 2026

(54) COMPOSITIONS COMPRISING MAGNESIUM OXIDE AND RARE EARTH METAL OXIDE

(71) Applicant: PRC-Desoto International, Inc., Sylmar, CA (US)

(72) Inventors: Guangliang Tang, Stevenson Ranch, CA (US); Mariette Painten Hickman, Long Beach, CA (US)

(73) Assignee: PRC-Desoto International, Inc., Sylmar, CA (US)

(21) Appl. No.: 19/155,578

(22) PCT Filed: Feb. 16, 2024
(86) PCT No.: PCT/US2024/016109

§ 371 Date: Aug. 12, 2025

Related U.S. Application Data
(60) Provisional application No. 63/485,390, filed on Feb. 16, 2023.

(51) Int. Cl. C23C 28/04; C23C 30/00

(52) U.S. Cl. CPC C23C 28/042; C23C 30/00

(57) ABSTRACT

The present disclosure is directed to a coating composition comprising: (a) a film-forming binder; (b) rare earth metal oxide particles; and (c) magnesium oxide particles having a particle size measured along a shortest axis of the particle of at least 1 micron. Also disclosed are coatings, coated metal substrates, multi-layer coated metal substrates, and methods for coating substrates.

### FIELD

The present disclosure is directed towards corrosion inhibiting coating compositions, methods of coating substrates, and coated substrates.

### BACKGROUND

Coatings are applied to appliances, automobiles, aircraft, and the like for a number of reasons, most notably for aesthetic reasons, corrosion protection and/or enhanced performance such as durability and protection from physical damage. To improve the corrosion resistance of a metal substrate, corrosion inhibitors may be used in the coatings applied to the substrate.

### SUMMARY

The present disclosure provides a coating composition comprising: (a) a film-forming binder; (b) rare earth metal oxide particles; and (c) magnesium oxide particles having a particle size measured along a shortest axis of the particle of at least 1 micron.

The present disclosure also provides a coated metal substrate comprising a metal substrate and a coating comprising a film-forming binder, magnesium oxide particles having a particle size measured along a shortest axis of the particle of at least 1 micron, and rare earth metal oxide particles.

The present disclosure further provides a multilayer coated metal substrate comprising: (a) a metal substrate; (b) a first coating layer present on at least a portion of said metal substrate; and (c) a second coating layer present on at least a portion of the first coating, wherein the first coating layer, the second coating layer or both layers comprise a coating comprising a film-forming binder, magnesium oxide particles having a particle size measured along a shortest axis of the particle of at least 1 micron, and rare earth metal oxide particles.

The present disclosure also provides a method for coating a substrate comprising applying a coating composition comprising: (a) a film-forming binder; (b) rare earth metal oxide particles; and (c) magnesium oxide particles having a particle size measured along a shortest axis of the particle of at least 1 micron to at least a portion of the substrate.

The present disclosure further provides a coating layer formed by at least partially curing a coating applied from a coating composition comprising: (a) a film-forming binder; (b) rare earth metal oxide particles; and (c) magnesium oxide particles having a particle size measured along a shortest axis of the particle of at least 1 micron.

### DETAILED DESCRIPTION

The present disclosure is directed to a coating composition comprising: (a) a film-forming binder; (b) rare earth metal oxide particles; and (c) magnesium oxide particles having a particle size measured along a shortest axis of the particle of at least 1 micron.

As used herein, the term “coating composition” refers to a solution, a mixture, a powder, or a dispersion, that, in cured state, is capable of forming a film, layer, or the like on a portion of a substrate surface. Examples of coating compositions include primers, basecoats, and/or topcoats.

The coating composition optionally may be in the form of a sealant composition. As used herein, the term “sealant composition” refers to a coating composition that, in a dried or cured state, forms a sealant having an elongation of at least 50% and/or at least 1 MPa load at failure measured according to ASTM D-412 with a pull rate of 50 mm/min and has the ability to resist atmospheric conditions, such as moisture and temperature and at least partially block the transmission of materials, such as water, fuel, and other liquids and gasses.

### Magnesium Oxide Particles

The coating composition comprises magnesium oxide particles.

The magnesium oxide particles act as a corrosion inhibitor. As used herein, the term “corrosion inhibitor” refers to a compound that inhibits corrosion of a metal substrate. The effectiveness of the corrosion inhibitor may be demonstrated by, for example, salt spray corrosion testing of a metal substrate according to ASTM B117. Whether a corrosion inhibitor improves corrosion resistance may be determined by testing the ability of the cured coating comprising the corrosion inhibitor to improve the corrosion performance as measured by one or more methods, such as through reduced scribe corrosion, scribe shine, and/or reduction in the number and/or size of blisters present in the coating adjacent to the scribe, when compared to a similar cured coating that does not include the corrosion inhibitor.

The shape (or morphology) of the magnesium oxide particles can vary. For example, generally spherical morphologies can be used, as well as particles that are cubic, platy, polyhedric, or acicular (elongated or fibrous). The particles may be covered completely in a polymeric gel, not covered at all in a polymeric gel, or covered partially with a polymeric gel. Covered partially with a polymeric gel means that a portion of the particle has a polymeric gel deposited thereon, which, for example, may be covalently bonded to the particle or merely associated with the particle.

At least a portion of the magnesium oxide particles may have a particle size measured along a shortest axis of the particle of at least 1 micron. As used herein, the particle size measured along the shortest axis may be determined by visually examining a micrograph of a transmission electron microscopy (“TEM”) image of the particle, measuring the diameter of the particles in the image along various axes, and determining the shortest axis based on the axis measured with magnification of the TEM image. One of ordinary skill in the art will understand how to prepare such a TEM image and determine the particle size based on the magnification.

The coating composition may comprise at least 1% by weight of magnesium oxide particles having a particle size measured along shortest axis of the particle of at least 1 micron, such as at least 2% by weight, such as at least 3% by weight, such as at least 5% by weight, such as at least 8% by weight, such as at least 10% by weight, based on the total solids weight of the coating composition. The coating composition may comprise no more than 50% by weight of magnesium oxide particles having a particle size measured along shortest axis of the particle of at least 1 micron, such as no more than 40% by weight, such as no more than 30% by weight, such as no more than 25% by weight, such as no more than 20% by weight, such as no more than 15% by weight, based on the total solids weight of the coating composition. The coating composition may comprise 1% to 50% by weight of magnesium oxide particles having a particle size measured along shortest axis of the particle of at least 1 micron, such as 1% to 40% by weight, such as 1% to 30% by weight, such as 1% to 25% by weight, such as 1% to 20% by weight, such as 1% to 15% by weight, such as 2% to 50% by weight, such as 2% to 40% by weight, such as 2% to 30% by weight, such as 2% to 25% by weight, such as 2% to 20% by weight, such as 2% to 15% by weight, such as 3% to 50% by weight, such as 3% to 40% by weight, such as 3% to 30% by weight, such as 3% to 25% by weight, such as 3% to 20% by weight, such as 3% to 15% by weight, such as 5% to 50% by weight, such as 5% to 40% by weight, such as 5% to 30% by weight, such as 5% to 25% by weight, such as 5% to 20% by weight, such as 5% to 15% by weight, such as 8% to 50% by weight, such as 8% to 40% by weight, such as 8% to 30% by weight, such as 8% to 25% by weight, such as 8% to 20% by weight, such as 8% to 15% by weight, such as 10% to 50% by weight, such as 10% to 40% by weight, such as 10% to 30% by weight, such as 10% to 25% by weight, such as 10% to 20% by weight, such as 10% to 15% by weight, based on the total solids weight of the coating composition.

At least a portion of the magnesium oxide particles may have a particle size measured along the shortest axis of the particle of no more than 500 nm. The coating composition may comprise at least 1% by weight of magnesium oxide particles having a particle size measured along shortest axis of the particle of no more than 500 nm, such as at least 2% by weight, such as at least 3% by weight, such as at least 5% by weight, such as at least 8% by weight, such as at least 10% by weight, based on the total solids weight of the coating composition. The coating composition may comprise no more than 50% by weight of magnesium oxide particles having a particle size measured along the shortest axis of the particle of no more than 500 nm, such as no more than 40% by weight, such as no more than 30% by weight, such as no more than 25% by weight, such as no more than 20% by weight, such as no more than 15% by weight, based on the total solids weight of the coating composition. The coating composition may comprise 1% to 50% by weight of magnesium oxide particles having a particle size measured along shortest axis of the particle of no more than 500 nm, such as 1% to 40% by weight, such as 1% to 30% by weight, such as 1% to 25% by weight, such as 1% to 20% by weight, such as 1% to 15% by weight, such as 2% to 50% by weight, such as 2% to 40% by weight, such as 2% to 30% by weight, such as 2% to 25% by weight, such as 2% to 20% by weight, such as 2% to 15% by weight, such as 3% to 50% by weight, such as 3% to 40% by weight, such as 3% to 30% by weight, such as 3% to 25% by weight, such as 3% to 20% by weight, such as 3% to 15% by weight, such as 5% to 50% by weight, such as 5% to 40% by weight, such as 5% to 30% by weight, such as 5% to 25% by weight, such as 5% to 20% by weight, such as 5% to 15% by weight, such as 8% to 50% by weight, such as 8% to 40% by weight, such as 8% to 30% by weight, such as 8% to 25% by weight, such as 8% to 20% by weight, such as 8% to 15% by weight, such as 10% to 50% by weight, such as 10% to 40% by weight, such as 10% to 30% by weight, such as 10% to 25% by weight, such as 10% to 20% by weight, such as 10% to 15% by weight, based on the total solids weight of the coating composition.

The magnesium oxide particles may comprise a bi-modal particle size distribution, such as comprising a first population of magnesium oxide particles having a particle size measured along the shortest axis of the particle of no more than 500 nm and a second population of magnesium oxide particles having a particle size measured along the shortest axis of the particle of at least 1 micron.

The particle size of the first population of magnesium oxide particles may be at least 2 times as large as the particle size of the second population of magnesium oxide particles, such as at least 3 times as large, such as at least 5 times as large, such as at least 10 times as large, such as at least 50 times as large, such as at least 100 times as large, such as at least 200 times as large, such as at least 250 times as large.

A weight ratio of the first population of magnesium oxide particles to the second population of magnesium oxide particles may be at least 1:3, such as at least 1:2, such as at least 1:1.2, such as at least 1:1, such as at least 1.2:1, such as at least 2:1, such as at least 3:1. A weight ratio of the first population of magnesium oxide particles to the second population of magnesium oxide particles may be no more than 3:1, such as no more than 2:1, such as no more than 1.2:1, such as no more than 1:1. A weight ratio of the first population of magnesium oxide particles to the second population of magnesium oxide particles may be from 1:3 to 3:1, such as 1:3 to 2:1, such as 1:3 to 1.2:1, such as 1:3 to 1:1, such as 1:2 to 3:1, such as 1:2 to 2:1, such as 1:2 to 1.2:1, such as 1:2 to 1:1, such as 1:1.2 to 3:1, such as 1:1.2 to 2:1, such as 1:1 to 3:1, such as 1:1 to 2:1, such as 1:1 to 1.2:1, such as 1.2:1 to 3:1, such as 1.2:1 to 2:1, such as 2:1 to 3:1.

The coating composition may comprise at least 1% by weight of total magnesium oxide particles, such as at least 2% by weight, such as at least 5% by weight, such as at least 10% by weight, such as at least 15% by weight, such as at least 20% by weight, based on the total solids weight of the coating composition. The coating composition may comprise no more than 70% by weight of total magnesium oxide particles, such as no more than 50% by weight, such as no more than 40% by weight, such as no more than 30% by weight, such as no more than 25% by weight, such as no more than 20% by weight, based on the total solids weight of the coating composition. The coating composition may comprise 1% to 70% by weight of total magnesium oxide particles, such as 1% to 50% by weight, such as 1% to 40% by weight, such as 1% to 30% by weight, such as 1% to 25% by weight, such as 1% to 20% by weight, such as 2% to 70% by weight, such as 2% to 50% by weight, such as 2% to 40% by weight, such as 2% to 30% by weight, such as 2% to 25% by weight, such as 2% to 20% by weight, such as 5% to 70% by weight, such as 5% to 50% by weight, such as 5% to 40% by weight, such as 5% to 30% by weight, such as 5% to 25% by weight, such as 5% to 20% by weight, such as 10% to 70% by weight, such as 10% to 50% by weight, such as 10% to 40% by weight, such as 10% to 30% by weight, such as 10% to 25% by weight, such as 10% to 20% by weight, such as 15% to 70% by weight, such as 15% to 50% by weight, such as 15% to 40% by weight, such as 15% to 30% by weight, such as 15% to 25% by weight, such as 15% to 20% by weight, such as 20% to 70% by weight, such as 20% to 50% by weight, such as 20% to 40% by weight, such as 20% to 30% by weight, such as 20% to 25% by weight, based on the total solids weight of the coating composition.

### Rare Earth Metal Oxide Particles

The coating composition further comprises rare earth metal oxide particles.

The rare earth metal oxide particles are and act as a corrosion inhibitor.

The rare earth metal oxide particles may comprise oxides of metals in Group IIIA of the Periodic Table, including scandium, yttrium, lanthanum, and lanthanides such as cerium, praseodymium, neodymium and the like, or any combination thereof.

The shape (or morphology) of the rare earth metal oxide particles can vary. For example, generally spherical morphologies can be used, as well as particles that are cubic, platy, polyhedric, or acicular (elongated or fibrous).

The particle size of the rare earth metal oxide particles is not limited. For example, the rare earth metal oxide particles may be nano-sized, micron-sized, or larger. For example, the rare earth metal oxide particles may have a particle size of 1 nanometer to 15 microns or larger, such as 500 nm to 12 microns, such as 1 micron to 10 microns, such as 3 microns to 8 microns, such as 5 microns to 7 microns.

The coating composition may comprise rare earth metal oxide particles in an amount of at least 1% by weight, such as at least 2% by weight, such as at least 3% by weight, such as at least 4% by weight, such as at least 5% by weight, such as at least 8% by weight, such as at least 10% by weight, based on the total solid weight of the coating composition. The coating composition may comprise rare earth metal oxide particles in an amount of no more than 50% by weight, such as no more than 40% by weight, such as no more than 30% by weight, such as no more than 20% by weight, such as no more than 15% by weight, such as no more than 10% by weight, such as no more than 6% by weight, such as no more than 3% by weight, based on the total solids weight of the coating composition. The coating composition may comprise rare earth metal oxide particles in an amount of 1% to 50% by weight, such as 1% to 40% by weight, such as 1% to 30% by weight, such as 1% to 20% by weight, such as 1% to 15% by weight, such as 1% to 10% by weight, such as 1% to 6% by weight, such as 1% to 3% by weight, such as 2% to 50% by weight, such as 2% to 40% by weight, such as 2% to 30% by weight, such as 2% to 20% by weight, such as 2% to 15% by weight, such as 2% to 10% by weight, such as 2% to 6% by weight, such as 2% to 3% by weight, such as such as 3% to 50% by weight, such as 3% to 40% by weight, such as 3% to 30% by weight, such as 3% to 20% by weight, such as 3% to 15% by weight, such as 3% to 10% by weight, such as 3% to 6% by weight, such as 4% to 50% by weight, such as 4% to 40% by weight, such as 4% to 30% by weight, such as 4% to 20% by weight, such as 4% to 15% by weight, such as 4% to 10% by weight, such as 4% to 6% by weight, such as 5% to 50% by weight, such as 5% to 40% by weight, such as 5% to 30% by weight, such as 5% to 20% by weight, such as 5% to 15% by weight, such as 5% to 10% by weight, such as 5% to 6% by weight, such as 8% to 50% by weight, such as 8% to 40% by weight, such as 8% to 30% by weight, such as 8% to 20% by weight, such as 8% to 15% by weight, such as 8% to 10% by weight, such as 10% to 50% by weight, such as 10% to 40% by weight, such as 10% to 30% by weight, such as 10% to 20% by weight, such as 10% to 15% by weight, based on the total solids weight of the coating composition.

A weight ratio of magnesium oxide particles to rare earth metal oxide particles may be at least 1:1, such as at least 1.5:1, such as at least 2:1, such as at least 3:1, such as at least 5:1, such as at least 6:1, such as at least 8:1, such as least 10:1, such as at least 15:1. A weight ratio of magnesium oxide particles to rare earth metal oxide particles may be no more than 15:1, such as no more than 10:1, such as no more than 8:1, such as no more than 6:1, such as no more than 5:1, such as no more than 4:1, such as no more than 3:1, such as no more than 2:1, such as no more than 1.5:1. A weight ratio of magnesium oxide particles to rare earth metal oxide particles is from 1:1 to 15:1, such as 1:1 to 10:1, such as 1:1 to 8:1, such as 1:1 to 6:1, such as 1:1 to 5:1, such as 1:1 to 4:1, such as 1:1 to 3:1, such as 1:1 to 2:1, such as 1.5:1 to 15:1, such as 1.5:1 to 10:1, such as 1.5:1 to 8:1, such as 1.5:1 to 6:1, such as 1.5:1 to 5:1, such as 1.5:1 to 4:1, such as 1.5:1 to 3:1, such as 1.5:1 to 2:1, such as 3:1 to 15:1, such as 3:1 to 10:1, such as 3:1 to 8:1, such as 3:1 to 6:1, such as 3:1 to 5:1, such as 3:1 to 4:1, such as 5:1 to 15:1, such as 5:1 to 10:1, such as 5:1 to 8:1, such as 5:1 to 6:1, such as 6:1 to 15:1, such as 6:1 to 10:1, such as 6:1 to 8:1, such as 8:1 to 15:1, such as 8:1 to 10:1, such as 10:1 to 15:1.

### Film-Forming Binder

The film-forming binder of the coating composition is not limited and may comprise any film forming binder, such as an organic film-forming binder, such as a curable organic film-forming binder, such as a thermoset organic film-forming binder, or such as a thermoplastic organic film-forming binder. Thermoset coating compositions may comprise film-forming binders that cure or crosslink under ambient conditions or with exposure to heat or other energy sources. Curing refers to bond formation, such as between a polymer and crosslinker, or self-crosslinking, resulting in the formation of a crosslinked coating film. Thermoplastic coating compositions may comprise film-forming binders that coalesce and/or dry to form a film upon evaporation of water and/or solvents.

The coating composition may comprise, for example, a film-forming binder comprising (a) an organic resin component and (b) a curing agent. Some coating compositions may self-crosslink, for example, wherein the composition comprises a polymer containing ethylenic unsaturation or olefinic double bonds that may cure by, for example, exposure to actinic radiation, or to oxygen in the air. For self-crosslinking coating compositions, by definition, the organic resin component (a) and the curing agent (b) may be the same or similar components. Alternatively, the coating composition may be thermoplastic.

The film-forming binder may comprise a curable, organic film-forming binder.

As used herein, the term “curable” and like terms refers to compositions that undergo a reaction in which they “set” irreversibly, such as when the components of the composition react with each other, and the polymer chains of the polymeric components are joined together by covalent bonds. This property is usually associated with a crosslinking reaction of the composition constituents often induced, for example, by heat or radiation. See Hawley, Gessner G., The Condensed Chemical Dictionary, Ninth Edition., page 856; Surface Coatings, vol. 2, Oil and Colour Chemists' Association, Australia, TAFE Educational Books (1974). Curing or crosslinking reactions also may be carried out under ambient conditions. By ambient conditions is meant that the coating undergoes a thermosetting reaction without the aid of heat or other energy, for example, without baking in an oven, use of forced air, or the like. Usually, ambient temperature ranges from 60 to 90° F. (15.6 to 32.2° C.), such as a typical room temperature, 72° F. (22.2° C.). Once cured or crosslinked, a thermosetting resin will not melt upon the application of heat and is insoluble in solvents.

As used herein, the term “organic film-forming binder” refers to carbon-based materials (resins, crosslinkers and the like, such as those further described below) that comprise less than 50 wt % of inorganic materials, based on the total weight of the binder component. The organic film-forming binder may comprise a mixture of organic and inorganic polymers and/or resins so long as the organic content comprises more than 50 wt % of the total weight of the organic film-forming binder, such as more than 60 wt %, such as more than 70 wt %, such as more than 80 wt %, such as more than 90 wt %. As used herein, “organic content” refers to carbon atoms as well as any hydrogen, oxygen, and nitrogen atoms that are bonded to a carbon atom.

Examples of resins or resin types that may be used in the coating compositions include polyester, alkyd, urethane, isocyanate, polyurea, epoxy, acrylic, polyether, polysulfide, polyamine, polyamide, polyvinyl chloride, polyolefin, polyvinylidene fluoride, polyvinyl chloride, polyolefin, polysiloxane, and derivatives or combinations thereof. The functional groups on the film-forming binder may be selected so as to be reactive with those on a curing agent. For example, the organic resin component may comprise a polymer having hydroxy functional groups, such as a hydroxy functional polyester, a hydroxy functional polyurethane, or a hydroxy functional acrylic.

Suitable epoxy functional polymers for use as the organic resin component (a) may include a polyepoxide chain extended by reacting together a polyepoxide and a polyhydroxyl group-containing material selected from alcoholic hydroxyl group-containing materials and phenolic hydroxyl group-containing materials to chain extend or build the molecular weight of the polyepoxide.

A chain extended polyepoxide is typically prepared by reacting together the polyepoxide and polyhydroxyl group-containing material neat or in the presence of an inert organic solvent such as a ketone, including methyl isobutyl ketone and methyl amyl ketone, aromatics such as toluene and xylene, and glycol ethers such as the dimethyl ether of diethylene glycol. The reaction is usually conducted at a temperature of 80° C. to 160° C. for 30 to 180 minutes until an epoxy group-containing resinous reaction product is obtained.

The equivalent ratio of reactants, i.e., epoxy:polyhydroxyl group-containing material, is typically from about 1.00:0.75 to 1.00:2.00. It will be appreciated by one skilled in the art that the chain extended polyepoxide will lack epoxide functional groups when reacted with the polyhydroxyl group-containing material such that an excess of hydroxyl functional groups is present. The resulting polymer will comprise hydroxyl functional groups resulting from the excess of hydroxyl functional groups and the hydroxyl functional groups produced by the ring-opening reaction of the epoxide functional groups.

The polyepoxide by definition has at least two 1,2-epoxy groups. In general, the epoxide equivalent weight of the polyepoxide may range from 100 to 2000, such as from 180 to 500. The epoxy compounds may be saturated or unsaturated, cyclic or acyclic, aliphatic, alicyclic, aromatic or heterocyclic. They may contain substituents such as halogen, hydroxyl, and ether groups.

Examples of polyepoxides are those having a 1,2-epoxy equivalency of one to two, such as greater than one and less than two or of two; that is, polyepoxides that have on average two epoxide groups per molecule. The most commonly used polyepoxides are polyglycidyl ethers of cyclic polyols, for example, polyglycidyl ethers of polyhydric phenols such as Bisphenol A, resorcinol, hydroquinone, benzenedimethanol, phloroglucinol, and catechol; or polyglycidyl ethers of polyhydric alcohols such as alicyclic polyols, such as cycloaliphatic polyols such as 1,2-cyclohexane diol, 1,4-cyclohexane diol, 2,2-bis(4-hydroxycyclohexyl)propane, 1,1-bis(4-hydroxycyclohexyl)ethane, 2-methyl-1,1-bis(4-hydroxycyclohexyl)propane, 2,2-bis(4-hydroxy-3-tertiarybutylcyclohexyl)propane, 1,3-bis(hydroxymethyl)cyclohexane and 1,2-bis(hydroxymethyl)cyclohexane. Examples of aliphatic polyols include, inter alia, trimethylpentanediol and neopentyl glycol.

Polyhydroxyl group-containing materials used to chain extend or increase the molecular weight of the polyepoxide may additionally be polymeric polyols such as any of those disclosed above. The present disclosure may comprise epoxy resins such as diglycidyl ethers of Bisphenol A, Bisphenol F, glycerol, novolacs, and the like. Exemplary suitable polyepoxides are described in U.S. Pat. No. 4,681,811 at column 5, lines 33 to 58, the cited portion of which is incorporated by reference herein. Examples of suitable commercially available epoxy resins include EPON 828, EPON 862, EPON 1001 and EPON 8111, all available from Westlake Epoxy, and D.E.N. 431 available from Olin.

Epoxy functional film-forming polymers may alternatively be acrylic polymers prepared with epoxy functional monomers such as glycidyl acrylate, glycidyl methacrylate, allyl glycidyl ether, and methallyl glycidyl ether. Polyesters, polyurethanes, or polyamides prepared with glycidyl alcohols or glycidyl amines, or reacted with an epihalohydrin are also suitable epoxy functional resins. Epoxide functional groups may be incorporated into a resin by reacting hydroxyl groups on the resin with an epihalohydrin or dihalohydrin such as epichlorohydrin or dichlorohydrin in the presence of alkali.

The amount of organic resin component (a) in the film-forming binder may be in an amount of at least 10% by weight, such as at least 20% by weight, such as at least 30% by weight, based on the total weight of resin solids in the coating composition. The amount of organic resin component (a) in the film-forming binder may be in an amount of no more than 90% by weight, such as no more than 80% by weight, such as no more than 75% by weight, based on the total weight of resin solids in the coating composition. The amount of organic resin component (a) in the film-forming binder may be in an amount of 10% to 90% by weight, such as 10% to 80% by weight, such as 10% to 75% by weight, such as 20% to 90% by weight, such as 20% to 80% by weight, such as 20% to 75% by weight, such as 30% to 90% by weight, such as 30% to 80% by weight, such as 30% to 75% by weight, based on the total weight of resin solids in the coating composition.

As used herein, the “resin solids” include the components of the film-forming binder of the coating composition. For example, the resin solids includes the components of the film-forming binder such as the organic resin component, the curing agent, and any additional resinous component(s) present in the coating composition.

According to the present disclosure, the film-forming binder may further comprise a curing agent (b). The terms “curing agent” “crosslinking agent” and “crosslinker” are herein used interchangeably and refers to a molecule capable of forming a covalent linkage between polymers or between two different regions of the same polymer. The curing agent (b) may react with the reactive functional groups of the organic resin component (a) to effectuate cure of the coating composition to form a cured coating. As used herein, the term “cure”, “cured” or similar terms, as used in connection with the coating compositions described herein, means that at least a portion of the components that form the film-forming binder are crosslinked to form a coating and is consistent with the term “curable” as defined above. Additionally, curing of the coating composition refers to subjecting said composition to curing conditions leading to the reaction of the reactive functional groups of the components of the coating composition, and resulting in the crosslinking of the components of the composition and formation of an at least partially cured coating.

Examples of suitable curing agents are polyisocyanates, at least partially blocked polyisocyanates, aminoplast resins, phenoplast resins, polyacids, epoxy, polyamines, polyamides, polythiols, polyols, polyenes, derivatives and some combinations thereof. As mentioned, for self-crosslinking coating compositions, the film-forming polymer and the curing agent may both comprise the same components and/or functionality such as ethylenic unsaturation or olefinic double bonds that may cure by, for example, exposure to actinic radiation, or to oxygen in the air.

Suitable polyamides may be prepared utilizing polyacids and polyamines. Suitable polyacids include, for example, adipic, succinic, sebacic, azelaic, and dodecanedioic acid and others, and polyamines may be comprise, for example, ethylene diamine, 1,2-diaminopropane, 1,4-diaminobutane, 1,3-diaminopentane, 1,6-diaminohexane, 2-methyl-1,5-pentane diamine, 2,5-diamino-2,5-dimethylhexane, 2,2,4- and/or 2,4,4-trimethyl-1,6-diamino-hexane, 1,11-diaminoundecane, 1,12-diaminododecane, 1,3- and/or 1,4-cyclohexane diamine, 1-amino-3,3,5-trimethyl-5-aminomethyl-cyclohexane, 2,4- and/or 2,6-hexahydrotoluylene diamine, 2,4′- and/or 4,4′-diamino-dicyclohexyl methane and 3,3′-dialkyl4,4′-diamino-dicyclohexyl methane (such as 3,3′-dimethyl-4,4′-diamino-dicyclohexyl methane and 3,3′-diethyl-4,4′-diamino-dicyclohexyl methane), 2,4- and/or 2,6-diaminotoluene and 2,4′- and/or 4,4′-diaminodiphenyl methane.

As an example, the coating composition may comprise any suitable organic resin component comprising a polymer having epoxy groups, such as, but not limited to, EPON 828, EPON 862, EPON 1001, or EPON 8111, all available from Westlake Epoxy, or combinations thereof, and the curing agent may comprise a crosslinker having amino groups such as, but not limited to Ancamine 2432, Ancamide 2569, Ancamine 2672, Ancamine 2686, or Ancamine K-54, all available from Evonik, and/or combinations thereof.

The curing agent may comprise one or more polyisocyanates and/or at least partially blocked polyisocyanates. Blocked polyisocyanates refer to polyisocyanates wherein the isocyanate groups have been reacted with a compound, such as an alcohol, such that the resultant blocked isocyanate group is stable to active hydrogens at ambient temperature, but reactive with active hydrogens at elevated temperature.

The curing agent may comprise an aminoplast resin. Nonlimiting examples of suitable aminoplast resins are CYMEL 303, CYMEL 385, CYMEL 1130, and CYMEL 1156, all commercially available from Allnex, and RESIMENE 747, RESIMENE 750, and RESIMENE 753, all available from Prefere Resins. Phenoplast resins, such as phenol formaldehyde condensates including allyl ether derivatives thereof, such as curing agents in the PHENODUR product line from Allnex that are suitable for coating compositions may also be useful in the coating composition.

The curing agent may comprise a polythiol curing agent. As used herein, a “polythiol curing agent” refers to a chemical compound having at least two thiol functional groups (—SH) that may be used to “cure” a composition by reacting with, for example, the epoxide functional group of an epoxy-containing compound to form a polymeric matrix.

The polythiol curing agent may comprise a compound comprising at least two thiol functional groups. For example, the polythiol curing agent may comprise a dithiol, trithiol, tetrathiol, pentathiol, hexathiol or higher functional polythiol compound. The polythiol curing agent may comprise a dithiol compound such as 3,6-dioxa-1,8-octanedithiol (DMDO), 3-oxa-1,5-pentanedithiol, 1,2-ethanedithiol, 1,3-propanedithiol, 1,2-propanedithiol, 1,4-butanedithiol, 1,3-butanedithiol, 2,3-butanedithiol, 1,5-pentanedithiol, 1,3-pentanedithiol, 1,6-hexanedithiol, 1,3-dithio-3-methylbutane, ethylcyclohexyldithiol (ECHDT), methylcyclohexyldithiol, methyl-substituted dimercaptodiethyl sulfide, dimethyl-substituted dimercaptodiethyl sulfide, 2,3-dimercapto-1-propanol, bis-(4-mercaptomethylphenyl) ether, 2,2′-thiodiethanethiol, and glycol dimercaptoacetate (commercially available as THIOCURE® GDMA from BRUNO BOCK Chemische Fabrik GmbH & Co. KG). The polythiol curing agent may comprise a trithiol compound such as trimethylolpropane trimercaptoacetate (commercially available as THIOCURE® TMPMA from BRUNO BOCK Chemische Fabrik GmbH & Co. KG), trimethylopropane tris-3-mercaptopropionate (commercially available as THIOCURE® TMPMP from BRUNO BOCK Chemische Fabrik GmbH & Co. KG), ethoxylated trimethylpropane tris-3-mercaptopropionate polymer (commercially available as THIOCURE® ETTMP from BRUNO BOCK Chemische Fabrik GmbH & Co. KG), tris[2-(3-mercaptopropionyloxy)ethyl]isocyanurate (commercially available as THIOCURE® TEMPIC from BRUNO BOCK Chemische Fabrik GmbH & Co. KG). The polythiol curing agent may comprise a tetrathiol compound such as pentaerythritol tetramercaptoacetate (commercially available as THIOCURE® PETMA from BRUNO BOCK Chemische Fabrik GmbH & Co. KG), pentaerythritol tetra-3-mercaptopropionate (commercially available as THIOCURE® PETMP from BRUNO BOCK Chemische Fabrik GmbH & Co. KG), and polycaprolactone tetra(3-mercaptopropionate) (commercially available as THIOCURE® PCL4MP 1350 from BRUNO BOCK Chemische Fabrik GmbH & Co. KG). Higher functional polythiol curing agents may include dipentaerythritol hexa-3-mercaptopropionate (commercially available as THIOCURE® DiPETMP from BRUNO BOCK Chemische Fabrik GmbH & Co. KG). Combinations of polythiol curing agents may also be used.

The polythiol curing agent may comprise a mercaptan terminated polysulfide. Commercially available mercaptan terminated polysulfides include those sold under the trade name THIOKOL® LP from Toray Fine Chemicals Co., Ltd., including, but not limited to, LP-3, LP-33, LP-23, LP-980, LP-2, LP-32, LP-12, LP-31, LP-55 and LP-56. The THIOKOL LP mercaptan terminated polysulfides have the general structure HS—(C₂H₄O—CH₂—O—C₂H₄—S—S)ₙC₂H₄—O—CH₂—O—C₂H₄—SH, wherein n is an integer of 5 to 50. Other commercially available mercaptan terminated polysulfides include those sold under the trade name THIOPLAST® G™ from Akzo Nobel Chemicals International B.V., including, but not limited to, G 10, G 112, G 131, G 1, G 12, G 21, G 22, G 44 and G 4. The THIOPLAST G mercaptan terminated polysulfides are blends of di- and tri-functional mercaptan-functional polysulfides with the di-functional unit having the structure HS—(R—S—S)ₙ—R—SH, wherein n is an integer from 7 to 38, and the tri-functional unit having the structure HS—(R—S—S)ₐ—CH₂—CH((S—S—R)_{c}—SH)—CH₂—(S—S—R)_{b}—SH, wherein a+b+c=n and n is an integer from 7 to 38.

The polythiol curing agent may comprise a mercaptan terminated polyether. Commercially available mercaptan terminated polyether include POLYTHIOL QE-340M available from Toray Fine Chemicals Co., Ltd.

The polythiol curing agent may comprise a thiol-terminated sulfur-containing polymer. The sulfur-containing polymer may comprise a polythioether, a polysulfide, and a combination thereof. The sulfur-containing polymer may comprise a mixture of different polythioethers and/or polysulfides, and the polythioethers and/or polysulfides may have the same or different functionality. In examples, the sulfur-containing polymer may have an average functionality of at least 2, such as no more than 6, such as no more than 4, such as no more than 3. In examples, the sulfur-containing polymer may have an average functionality of 2 to 6, such as 2 to 4, such as 2 to 3, such as 2.05 to 2.8. For example, a sulfur-containing polymer can be selected from a difunctional sulfur-containing polymer, a trifunctional sulfur-containing polymer, and a combination thereof.

In examples, a sulfur-containing polymer may be thiol-terminated, and in examples, may comprise a thiol-terminated polythioether. Examples of thiol-terminated polythioethers are disclosed, for example, in U.S. Pat. No. 6,172,179. In examples, a thiol-terminated polythioether may comprise Permapol® P3.1E, available from PPG Aerospace, Sylmar, CA.

The polythiol curing agent may have a thiol equivalent weight of at least 80 g/eq, such as at least 100 g/eq, such as at least 125 g/eq, such as more than 600 g/eq, and may have a thiol equivalent weight of no more than 2,500 g/eq, such as no more than 2,000 g/eq, such as no more than 1,650 g/eq, such as no more than 600 g/eq. The polythiol curing agent may have a thiol equivalent weight of 80 g/eq to 2,500 g/eq, such as 100 g/eq to 2,000 g/eq, such as 125 g/eq to 1,650 g/eq, such as 80 g/eq to 600 g/eq, such as more than 600 g/eq to 2,500 g/eq.

The polythiol curing agent may be present in the composition in an amount such that the ratio of the epoxide equivalent weight of epoxy-containing compound to the thiol equivalent weight of the polythiol curing agent may be at least 1:30, such as at least 1:12, and may be no more than 10:1, such as no more than 4:1. The polythiol curing agent may be present in the composition in an amount such that the ratio of the epoxide equivalent weight of epoxy compounds to the thiol equivalent weight of the polythiol curing agent may be 1:30 to 10:1, such as 1:12 to 4:1.

The curing agent may optionally comprise a high molecular weight volatile group. As used herein, the term “high molecular weight volatile group” refers to blocking agents and other organic byproducts that are released or produced and volatilized during the curing reaction of the coating composition having a molecular weight of at least 70 g/mol, such as at least 125 g/mol, such as at least 160 g/mol, such as at least 195 g/mol, such as at least 400 g/mol, such as at least 700 g/mol, such as at least 1000 g/mol, or higher, and may range from 70 to 1,000 g/mol, such as 160 to 1,000 g/mol, such as 195 to 1,000 g/mol, such as 400 to 1,000 g/mol, such as 700 to 1,000 g/mol. For example, the organic byproducts may include alcoholic byproducts resulting from the reaction of the film-forming polymer and an aminoplast or phenoplast curing agent. A methylated melamine-formaldehyde curing agent comprising a butyl carbitol (2-(2-butoxyethoxy) ethanol), or other high molecular weight volatile group, may be used as a curing agent with high molecular weight volatile groups. The organic byproducts may include alcoholic byproducts of the blocking agents, used to block isocyanato groups of polyisocyanates that are unblocked during cure. For clarity, the high molecular weight volatile groups are covalently bound to the curing agent prior to cure, and explicitly exclude any organic solvents that may be present in the coating composition.

Appropriate mixtures of crosslinking agents may also be used.

It will be appreciated that the coating composition may comprise any film forming binder, such as a film forming resin, and a curing agent, magnesium oxide particles, and rare earth metal oxide particles, such as yttrium oxide particles, as discussed above. The coating composition may comprise a polymer having epoxide functional groups, a curing agent or crosslinker comprising amino functional groups, magnesium oxide particles, and rare earth metal oxide particles, such as yttrium oxide particles, or the coating composition may comprise a polymer having hydroxyl functional groups, a curing agent comprising isocyanato functional groups, magnesium oxide particles, and rare earth metal oxide particles, such as yttrium oxide particles.

The curing agent (b) may be present in an amount of at least 5% by weight, such as at least 10% by weight, such as at least 15% by weight, based on the total weight of resin solids in the coating composition. The curing agent (b) may be present in an amount of no more than 75% by weight, such as no more than 60% by weight, such as no more than 50% by weight, based on the total weight of resin solids in the coating composition. The curing agent (b) may be present in an amount of 5% to 75% by weight, such as 5% to 50% by weight, such as 5% to 60% by weight, such as 10% to 75% by weight, such as 10% to 60% by weight, such as 10% to 50% by weight, such as 15% to 75% by weight, such as 15% to 60% by weight, such as 15% to 50% by weight, based on the total weight of resin solids in the coating composition.

The film-forming binder may be present in the coating composition in an amount of at least 29% by weight, such as at least 35% by weight, such as at least 40% by weight, such as at least 45% by weight, such as at least 50% by weight, based on the total solids weight of the coating composition. The film-forming binder may be present in the coating composition in an amount of no more than 98% by weight, such as no more than 75% by weight, such as no more than 65% by weight, such as no more than 60% by weight, such as no more than 55% by weight, based on the total solids weight of the coating composition. The film-forming binder may be present in the coating composition in an amount of 29% to 98% by weight, such as 29% to 75% by weight, such as 29% to 65% by weight, such as 29% to 60% by weight, such as 29% to 55% by weight, such as 35% to 98% by weight, such as 35% to 75% by weight, such as 35% to 65% by weight, such as 35% to 60% by weight, such as 35% to 55% by weight, such as 40% to 98% by weight, such as 40% to 75% by weight, such as 40% to 65% by weight, such as 40% to 60% by weight, such as 40% to 55% by weight, such as 45% to 98% by weight, such as 245% to 75% by weight, such as 45% to 65% by weight, such as 45% to 60% by weight, such as 45% to 55% by weight, such as 50% to 98% by weight, such as 50% to 75% by weight, such as 50% to 65% by weight, such as 50% to 60% by weight, such as 50% to 55% by weight, based on the total solids weight of the coating composition.

### Further Components of the Coating Compositions

The coating composition according to the present disclosure may optionally comprise one or more further components in addition to the film-forming binder, magnesium oxide, and rare earth metal oxide described above.

The coating composition may optionally further comprise calcium sulfate (i.e., gypsum). If present, calcium sulfate may be present in an amount of at least 1% by weight, such as at least 5% by weight, such as at least 10% by weight, such as at least 15% by weight, based on the total solids weight of the coating composition. If present, calcium sulfate may be present in an amount of no more than 30% by weight, such as no more than 25% by weight, such as no more than 20% by weight, based on the total solids weight of the coating composition. If present, calcium sulfate may be present in an amount of 1% to 30% by weight, such as 1% to 25% by weight, such as 1% to 20% by weight, such as 5% to 30% by weight, such as 5% to 25% by weight, such as 5% to 20% by weight, such as 10% to 30% by weight, such as 10% to 25% by weight, such as 10% to 20% by weight, such as 15% to 30% by weight, such as 15% to 25% by weight, such as 15% to 20% by weight, based on the total solids weight of the coating composition.

The coating compositions of the present disclosure may optionally further comprise one or more additional corrosion inhibitors.

Amino acid(s) are suitable additional corrosion inhibitors according to the present disclosure. Amino acids will be understood by those skilled in the art as compounds having both acid and amine functionality, with side chains specific to each amino acid. The amino acid may be monomeric or oligomeric, including a dimer. When an oligomeric amino acid is used, the molecular weight, as determined by GPC, of the oligomer is often less than 1000.

Suitable amino acids are histidine, arginine, lysine, cysteine, cystine, tryptophan, methionine, phenylalanine and tyrosine. Mixtures may also be used. The amino acids can be either L- or D-enantiomers, which are mirror images of each other, or mixtures thereof. The L-configurations are typically found in proteins and nature and as such are widely commercially available. The term “amino acids” as used herein therefore refers to both the D- and L-configurations; it is foreseen that only the L- or only the D-configuration may be included. Amino acids can be purchased, for example, from Sigma Aldrich, Thermo Fisher Scientific, Hawkins Pharmaceutical, or Ajinomato. Often the amino acids glycine, arginine, proline, cysteine and/or methionine are specifically excluded.

The amino acid can be present in any amount that improves the corrosion resistance of the coating. For example, the amino acid may be present in an amount of 0.1 to 20 percent by weight, such as at least 0.1 percent by weight or at least 2 percent by weight and at most 20 percent by weight or at most 4 percent by weight; exemplary ranges include 0.1 to 4 percent by weight, 2 to 4 percent by weight, or 2 to 20 percent by weight, based on the total weight of resin solids in the coating composition.

Alternatively, the composition may be substantially free, essentially free, or completely free of amino acid corrosion inhibitors. As used herein, the term “substantially free” with respect to amino acid corrosion inhibitors means that the material is present in the composition, if at all, an in amount of less than 0.1% by weight, based on the total weight of the composition. As used herein, the term “essentially free” with respect to amino acid corrosion inhibitors means that the material is present in the composition, if at all, in an amount of less than 0.05% by weight, based on the total weight of the composition. As used herein, the term “completely free” with respect to amino acid corrosion inhibitors means that the material is not present in the composition at all, i.e., 0.00% by weight, based on the total weight of the composition.

An azole may also be a suitable additional corrosion inhibitor. Examples of suitable azoles include benzotriazoles such as 5-methyl benzotriazole, tolyltriazole, 2,5-dimercapto-1,3,4-thiadiazole, 2-mercaptobenzothiazole, 2-mercaptobenzimidazole, 1-phenyl-5-mercaptotetrazole, 2-amino-5-mercapto-1,3,4-thiadiazole, 2-mercapto-1-methylimidazole, 2-amino-5-ethyl-1,3,4-thiadiazole, 2-amino-5-ethylthio-1,3,4-thiadiazole, 5-phenyltetrazole, 7h-imidazo(4,5-d)pyrimidine, and 2-amino thiazole. Salts of any of the foregoing, such as sodium and/or zinc salts, are also suitable. Additional azoles include 2-hydroxybenzothiazole, benzothiazole, 1-phenyl-4-methylimidazole, and 1-(p-tolyl)-4-methlyimidazole. A suitable azole-containing product is commercially available from WPC Technologies, as HYBRICOR 204, Hybricor 204S, and Inhibicor 1000. Mixtures of azoles may also be used. Typically, the azole is present in the coating composition, if used, in amounts as low as 0.1 percent, such as 0.1 to 25 percent by weight, based on total weight of resin solids in the coating composition.

Alternatively, the composition may be substantially free, essentially free, or completely free of azole corrosion inhibitors. As used herein, the term “substantially free” with respect to azole corrosion inhibitors means that the material is present in the composition, if at all, an in amount of less than 0.1% by weight, based on the total weight of the composition. As used herein, the term “essentially free” with respect to azole corrosion inhibitors means that the material is present in the composition, if at all, in an amount of less than 0.05% by weight, based on the total weight of the composition. As used herein, the term “completely free” with respect to azole corrosion inhibitors means that the material is not present in the composition at all, i.e., 0.00% by weight, based on the total weight of the composition.

Lithium-based compounds are also another suitable additional corrosion inhibitor. Lithium-based compounds can be used, for example, in salt form, such as an organic or inorganic salt. Examples of suitable lithium salts include but are not limited to lithium carbonate, lithium phosphate, lithium sulphate, and lithium tetraborate. Other lithium compounds include but are not limited to lithium silicate including lithium orthosilicate (Li₄SiO₄), lithium metasilicate (Li₂SiO₃), lithium zirconate, and lithium-exchanged silica particles. If used, a lithium compound can be used in amounts of 0.1 to 4.5 percent of lithium by weight, based on the total weight of resin solids in the coating composition.

Alternatively, the composition may be substantially free, essentially free, or completely free of lithium-based compounds. As used in this context, “substantially free” means the lithium-based compound, if present at all, is only present in trace amounts, such as less than 0.1% by weight of lithium, “essentially free” means the lithium compound, if present at all, is only present in an amount of less than 0.05% by weight of lithium, and “completely free” means the lithium-based compound is not present in the coating composition, i.e., 0.00% by weight of lithium, the % by weight based on the resin solids weight of the coating composition.

The coating composition may be substantially free, essentially free, or completely free of chromium-containing material. As used herein, the term “chromium-containing material” refers to materials that include a chromium trioxide group, CrO₃. Examples of such materials include chromic acid, chromium trioxide, chromic acid anhydride, dichromate salts, such as ammonium dichromate, sodium dichromate, potassium dichromate, and calcium, barium, magnesium, zinc, cadmium, and strontium dichromate. As used herein, the term “substantially free” with respect to chromium-containing material means that the material is present in the composition, if at all, an in amount of less than 2% by weight, based on the total weight of the composition. As used herein, the term “essentially free” with respect to chromium-containing material means that the material is present in the composition, if at all, an in amount of less than 0.05% by weight, based on the total weight of the composition. As used herein, the term “completely free” means that the material is not present in the composition at all.

The coating compositions of the present disclosure may be provided and stored as one-package compositions prior to use. A one-package composition will be understood as referring to a composition wherein all the coating components are maintained in the same container after manufacture, during storage, etc. A typical one-package coating can be applied to a substrate and cured by any conventional means, such as by heating, forced air, radiation cure and the like. For some coatings, such as ambient cure coatings, it is not practical to store them as a one-package, but rather they must be stored as multi-package coatings to prevent the components from curing prior to use. The term “multi-package coatings” means coatings in which various components are maintained separately until just prior to application. The present coatings can also be multi-package coatings, such as a two-package coating.

Thus, the components (a) and (b) may be provided as a one-package (1K) or multi-package, such as a two-package (2K) system. For two-package systems, the components of the film-forming binder may be provided in separate packages and mixed together immediately prior to the reaction. The magnesium oxide and rare earth metal oxide may be present in either one or both of the separate components (a) and (b) and/or as an additional separate component package.

The coating composition may include optional ingredients commonly used in such compositions. For example, the composition may further comprise a hindered amine light stabilizer for UV degradation resistance. Such hindered amine light stabilizers include those disclosed in U.S. Pat. No. 5,260,135. When they are used, they are typically present in the composition in an amount of 0.1 to 2 percent by weight, based on the total weight of resin solids in the film-forming composition. Other optional additives may be included such as colorants, plasticizers, abrasion-resistant particles, film strengthening particles, flow control agents, thixotropic agents, rheology modifiers, fillers, catalysts, antioxidants, biocides, defoamers, surfactants, wetting agents, dispersing aids, adhesion promoters, UV light absorbers and stabilizers, a stabilizing agent, organic cosolvents, reactive diluents, grind vehicles, and other customary auxiliaries, or combinations thereof. The term “colorant”, as used herein is as defined in U.S. Patent Publication No. 2012/0149820, paragraphs 29 to 38, the cited portion of which is incorporated herein by reference.

An “abrasion-resistant particle” is one that, when used in a coating, will impart some level of abrasion resistance to the coating as compared with the same coating lacking the particles. Suitable abrasion-resistant particles include organic and/or inorganic particles. Examples of suitable organic particles include, but are not limited to, diamond particles, such as diamond dust particles, and particles formed from carbide materials; examples of carbide particles include, but are not limited to, titanium carbide, silicon carbide and boron carbide. Examples of suitable inorganic particles, include but are not limited to silica; alumina; alumina silicate; silica alumina; alkali aluminosilicate; borosilicate glass; nitrides including boron nitride and silicon nitride; oxides including titanium dioxide and zinc oxide; quartz; nepheline syenite; zircon such as in the form of zirconium oxide; buddeluyite; and eudialyte. Particles of any size can be used, as can mixtures of different particles and/or different sized particles.

As used herein, the terms “adhesion promoter” and “adhesion promoting component” refer to any material that, when included in the composition, enhances the adhesion of the coating composition to a metal substrate. Such an adhesion promoting component often comprises a free acid. As used herein, the term “free acid” is meant to encompass organic and/or inorganic acids that are included as a separate component of the compositions as opposed to any acids that may be used to form a polymer that may be present in the composition. The free acid may comprise tannic acid, gallic acid, phosphoric acid, phosphorous acid, citric acid, malonic acid, a derivative thereof, or a mixture thereof. Suitable derivatives include esters, amides, and/or metal complexes of such acids. Often, the free acid comprises a phosphoric acid, such as a 100 percent orthophosphoric acid, superphosphoric acid or the aqueous solutions thereof, such as a 70 to 90 percent phosphoric acid solution.

In addition to or in lieu of such free acids, other suitable adhesion promoting components are metal phosphates, organophosphates, and organophosphonates. Suitable organophosphates and organophosphonates include those disclosed in U.S. Pat. No. 6,440,580 at column 3, line 24 to column 6, line 22, U.S. Pat. No. 5,294,265 at column 1, line 53 to column 2, line 55, and U.S. Pat. No. 5,306,526 at column 2, line 15 to column 3, line 8, the cited portions of which are incorporated herein by reference. Suitable metal phosphates include, for example, zinc phosphate, iron phosphate, manganese phosphate, calcium phosphate, magnesium phosphate, cobalt phosphate, zinc-iron phosphate, zinc-manganese phosphate, zinc-calcium phosphate, including the materials described in U.S. Pat. Nos. 4,941,930, 5,238,506, and 5,653,790.

The adhesion promoting component may comprise a phosphatized epoxy resin. Such resins may comprise the reaction product of one or more epoxy-functional materials and one or more phosphorus-containing materials. Examples of such materials, which are suitable for use in the present disclosure, are disclosed in U.S. Pat. No. 6,159,549 at column 3, lines 19 to 62, the cited portion of which is incorporated by reference herein.

The coating composition may also optionally comprise alkoxysilane adhesion promoting agents, for example, acryloxyalkoxysilanes, such as γ-acryloxypropyltrimethoxysilane and methacrylatoalkoxysilane, such as γ-methacryloxypropyltrimethoxysilane, as well as epoxy-functional silanes, such as γ-glycidoxypropyltrimethoxysilane. Exemplary suitable alkoxysilanes are described in U.S. Pat. No. 6,774,168 at column 2, lines 23 to 65, the cited portion of which is incorporated by reference herein.

The adhesion promoting component, if used, is usually present in the coating composition in an amount of 0.05 to 20 percent by weight, such as at least 0.05 percent by weight or at least 0.25 percent by weight, and at most 20 percent by weight or at most 15 percent by weight, such as 0.05 to 15 percent by weight, 0.25 to 15 percent by weight, or 0.25 to 20 percent by weight, with the percentages by weight being based on the total weight of resin solids in the composition.

The coating compositions of the present disclosure may also comprise, in addition to any of the previously described corrosion inhibiting compounds, any other corrosion resisting particles including, but are not limited to, iron phosphate, zinc phosphate, calcium ion-exchanged silica, colloidal silica, synthetic amorphous silica, and molybdates, such as calcium molybdate, zinc molybdate, barium molybdate, strontium molybdate, and mixtures thereof. Suitable calcium ion-exchanged silica is commercially available from W. R. Grace & Co. as SHIELDEX AC3 and/or SHIELDEX. C303. Suitable amorphous silica is available from W. R. Grace & Co. as SYLOID. Suitable zinc hydroxyl phosphate is commercially available from Elementis Specialties, Inc. as NALZIN. 2. These particles, if used, may be present in the compositions of the present disclosure in an amount of 5 to 40 percent by weight, such as at least 5 percent by weight or at least 10 percent by weight, and at most 40 percent by weight or at most 25 percent by weight, such as 10 to 25 percent by weight, with the percentages by weight being based on the total solids weight of the composition.

The coating compositions of the present disclosure may comprise a liquid medium including water and/or organic solvents. Suitable organic solvents include glycols, glycol ether alcohols, alcohols, ketones, and aromatics, such as xylene and toluene, acetates, mineral spirits, naphthas and/or mixtures thereof. “Acetates” include the glycol ether acetates. The liquid medium can be a non-aqueous medium or organic solvent-based medium such that the composition is solventborne. “Non-aqueous medium,” “solventborne,” and like terms means that less than 50 wt % of the solvent is water with the balance being organic solvent(s). For example, less than 10 wt %, or less than 5 wt %, or less than 2 wt %, or less than 1 wt %, or 0 wt %, of the liquid medium can be water. It will be understood that mixtures of solvents, including water in an amount of less than 50 wt % or containing no water, can constitute a “non-aqueous medium” and a “solventborne” composition. The composition may be aqueous or water-based or waterborne. This means that more than 50 wt % of the liquid medium is water. Such compositions have less than 50 wt %, such as less than 20 wt %, less than 10 wt %, less than 5 wt % or less than 2 wt % of organic solvent(s).

### Substrates

According to the present disclosure, the coating composition may be applied to a substrate. Suitable substrates include metal substrates, metal alloy substrates, and/or substrates that have been metallized, such as nickel-plated plastic. Additionally, substrates may comprise non-metal conductive materials including composite materials such as, for example, materials comprising carbon fibers or conductive carbon. According to the present disclosure, the metal or metal alloy may comprise, for example, cold rolled steel, hot rolled steel, steel coated with zinc metal, zinc compounds, or zinc alloys, such as electrogalvanized steel, hot-dipped galvanized steel, galvanealed steel, GALVANNEAL steel, nickel-plated steel, and steel plated with zinc alloy. Steel substrates (such as cold rolled steel or any of the steel substrates listed above) coated with a weldable, zinc-rich or iron phosphide-rich organic coating are also suitable for use in the present disclosure. Such weldable coating compositions are disclosed in U.S. Pat. Nos. 4,157,924 and 4,186,036. The substrate may comprise aluminum, aluminum alloys, zinc-aluminum alloys such as GALFAN, GALVALUME, aluminum plated steel, and aluminum alloy plated steel substrates. Examples of aluminum alloys include the 1XXX, 2XXX, 3XXX, 4XXX, 5XXX, 6XXX, or 7XXX series, such as 2024, 7075, 6061 as particular examples, as well as clad aluminum alloys and cast aluminum alloys, such as, for example, the A356 series. The substrate may comprise a magnesium alloy. Examples of magnesium alloys of the AZ31B, AZ91C, AM60B, or EV31A series also may be used as the substrate. The substrate used in the present disclosure may also comprise other suitable non-ferrous metals such as titanium or copper, as well as alloys of these materials. The substrate may also comprise more than one metal or metal alloy in that the substrate may be a combination of two or more metal substrates assembled together such as hot-dipped galvanized steel assembled with aluminum substrates.

Suitable metal substrates for use in the present disclosure include those that are often used in the assembly of vehicular bodies (e.g., without limitation, door, body panel, trunk deck lid, roof panel, hood, roof and/or stringers, rivets, landing gear components, and/or skins used on an aircraft), a vehicular frame, vehicular parts, motorcycles, wheels, industrial structures and components such as appliances, including washers, dryers, refrigerators, stoves, dishwashers, and the like, agricultural equipment, lawn and garden equipment, air conditioning units, heat pump units, lawn furniture, and other articles. The substrate may comprise a vehicle or a portion or part thereof. The term “vehicle” is used in its broadest sense and includes all types of aircraft, spacecraft, watercraft, and ground vehicles. For example, a vehicle can include aircraft such as airplanes including private aircraft, and small, medium, or large commercial passenger, freight, and military aircraft; helicopters, including private, commercial, and military helicopters; drones, aerospace vehicles including, rockets and other spacecraft. A vehicle can include a ground vehicle such as, for example, trailers, cars, trucks, buses, vans, construction vehicles, golf carts, motorcycles, bicycles including electric bicycles, trains, and railroad cars. A vehicle can also include watercraft such as, for example, ships, boats, and hovercraft. The aqueous resinous dispersion may be utilized to coat surfaces and parts thereof. A part may include multiple surfaces. A part may include a portion of a larger part, assembly, or apparatus. A portion of a part may be coated with the aqueous resinous dispersion of the present disclosure, or the entire part may be coated.

The metal substrate may be in the shape of a cylinder, such as a pipe, including, for example, a cast iron pipe. The metal substrate also may be in the form of, for example, a sheet of metal or a fabricated part. The substrate may also comprise conductive or non-conductive substrates at least partially coated with a conductive coating. The conductive coating may comprise a conductive agent such as, for example, graphene, conductive carbon black, conductive polymers, or conductive additives. It will also be understood that the substrate may be pretreated with a pretreatment solution. Examples of a pretreatment solution include a zinc phosphate pretreatment solution such as, for example, those described in U.S. Pat. Nos. 4,793,867 and 5,588,989, a zirconium containing pretreatment solution such as, for example, those described in U.S. Pat. Nos. 7,749,368 and 8,673,091. Other examples of a pretreatment solution include those comprising trivalent chromium, hexavalent chromium, lithium salts, permanganate, rare earth metals, such as yttrium, or lanthanides, such as cerium. Another example of a suitable surface pretreatment solution is a solgel, such as those comprising alkoxy-silanes, alkoxy-zirconates, and/or alkoxy-titanates. Alternatively, the substrate may be a non-pretreated substrate, such as a bare substrate, which is not pretreated by a pretreatment solution.

The substrate may optionally be subjected to other treatments prior to coating. For example, the substrate may be cleaned, cleaned and deoxidized, anodized, acid pickled, plasma treated, laser treated, or ion vapor deposition (JVD) treated. These optional treatments may be used on their own or in combination with a pretreatment solution. The substrate may be new (i.e., newly constructed or fabricated) or it may be refurbished, such as, for example, in the case of refinishing or repairing a component of an automobile or aircraft.

### Methods of Coating, Coatings and Coated Substrates

The present disclosure is also directed to methods for coating a substrate, such as any one of the substrates mentioned above.

The coating compositions of the present disclosure may be applied to at least a portion of a surface to form a coating. The compositions may be applied by known application techniques, such as dipping, immersing, intermittent spraying, dipping followed by spraying, spraying followed by dipping, brushing, or roll-coating. Usual spray techniques and equipment for air spraying and electrostatic spraying, either manual or automatic methods, can be used.

After application of the composition to the substrate, a film or coating is formed on the surface of the substrate by driving solvent, i.e., organic solvent and/or water, out of the film by heating or by an air-drying period. Suitable drying conditions will depend on the particular composition and/or application, but in some instances a drying time of from about 1 to 5 minutes at a temperature of about 70 to 250° F. (27 to 121° C.) will be sufficient. More than one coating layer of the present composition may be applied if desired. Usually between coats, the previously applied coat is flashed; that is, exposed to ambient conditions for the desired amount of time. The thickness of the coating is usually from 0.1 to 3 mils (2.5 to 75 microns), such as 0.2 to 2.0 mils (5.0 to 50 microns). The coating composition may then be heated. In the curing operation, solvents are driven off and crosslinkable components of the composition are crosslinked. The heating and curing operation is sometimes carried out at a temperature in the range of 70 to 250° F. (27 to 121° C.) but, if needed, lower or higher temperatures may be used. As noted previously, the coatings of the present disclosure may also cure without the addition of heat or a drying step. Additionally, the first coating composition may be applied and then a second applied thereto “wet-on-wet”. Alternatively, the first coating composition can be cured before application of one or more additional coating layers.

The present disclosure is further directed to a coating layer formed by at least partially curing the coating applied from the coating composition described herein.

The present disclosure is further directed to a substrate that is coated, at least in part, with the coating composition described herein.

Coated metal substrates of the present disclosure may demonstrate excellent corrosion resistance as determined by salt spray coiTosion resistance testing.

The coating compositions of the present disclosure may be used alone such as a unicoat, or monocoat, layer and/or may be used as part of a multi-layer coating system. For example, the compositions of the present disclosure may be used as primers, basecoats, and/or topcoats. Thus, the present disclosure is further directed to a multilayer coated metal substrate. Such a multilayer coated substrate comprises (a) a metal substrate; (b) a first coating layer formed on at least a portion of a surface of the metal substrate; and (c) a second coating layer formed on at least a portion of the first coating, wherein the first coating layer, the second coating layer or both layers comprise a coating comprising: a film-forming binder; magnesium oxide particles having a particle size measured along a shortest axis of the particle of at least 1 micron; and rare earth metal oxide particles. For example, the first coating layer may be a primer coating applied to the substrate and the second coating layer may be a topcoat composition. One or more additional corrosion inhibitors may be present in either the first or second coating layers or both.

The coating composition of the present disclosure may be applied directly to the metal substrate when there is no intermediate coating between the substrate and the coating composition. By this is meant that the substrate may be bare, as described below, or may be treated with one or more cleaning, deoxidizing, and/or pretreatment compositions as described below, or the substrate may be anodized. Alternatively, the substrate may be coated with one or more different coating compositions prior to application of the coating composition of the present disclosure. The additional coating layers may comprise solgels, adhesion promoters, primers, wash primers, basecoats, or topcoats, and may be applied by any method known in the art, such as, for example, dip, roll, spray, brush, or electrodeposition.

As noted above, the substrates to be used may be bare metal substrates. By “bare” is meant a virgin metal substrate that has not been treated with any pretreatment compositions such as conventional phosphating baths, heavy metal rinses, etc. Additionally, bare metal substrates being used in the present disclosure may be a cut edge of a substrate that is otherwise treated and/or coated over the rest of its surface. Alternatively, the substrates may undergo one or more treatment steps known in the art prior to the application of the coating composition.

The substrate may optionally be cleaned using conventional cleaning procedures and materials. Such cleaners include mild or strong alkaline cleaners such as are commercially available and conventionally used in metal pretreatment processes. Examples of alkaline cleaners include Chemkleen 163 and Chemkleen 177, both of which are available from PPG Industries, Pretreatment and Specialty Products, and any of the DFM Series, RECC 1001, and 88X1002 cleaners commercially available from PRC-DeSoto International, Sylmar, CA), and Turco 4215-NCLT and Ridolene (commercially available from Henkel Technologies, Madison Heights, MI). Such cleaners are often preceded or followed by a water rinse, such as with tap water, distilled water, or combinations thereof. The metal surface may also be rinsed with an aqueous acidic solution after or in place of cleaning with the alkaline cleaner. Examples of rinse solutions include mild or strong acidic cleaners such as the dilute nitric acid solutions commercially available and conventionally used in metal pretreatment processes.

According to the present disclosure, at least a portion of a cleaned aluminum substrate surface may be deoxidized, mechanically or chemically. As used herein, the term “deoxidize” means removal of the oxide layer found on the surface of the substrate in order to promote uniform deposition of the pretreatment composition (described below), as well as to promote the adhesion of the pretreatment composition coating and/or coating composition of the present disclosure to the substrate surface. Suitable deoxidizers will be familiar to those skilled in the art. A typical mechanical deoxidizer may be uniform roughening of the substrate surface, such as by using a scouring or cleaning pad. Typical chemical deoxidizers include, for example, acid-based deoxidizers such as phosphoric acid, nitric acid, fluoroboric acid, sulfuric acid, chromic acid, hydrofluoric acid, and ammonium bifluoride, or Amchem 7/17 deoxidizers (available from Henkel Technologies, Madison Heights, MI), OAKITE DEOXIDIZER LNC (commercially available from Chemetall), TURCO DEOXIDIZER 6 (commercially available from Henkel), or combinations thereof. Often, the chemical deoxidizer comprises a carrier, often an aqueous medium, so that the deoxidizer may be in the form of a solution or dispersion in the carrier, in which case the solution or dispersion may be brought into contact with the substrate by any of a variety of known techniques, such as dipping or immersion, spraying, intermittent spraying, dipping followed by spraying, spraying followed by dipping, brushing, or roll-coating.

The metal substrate may optionally be pickled by treatment with solutions comprising nitric acid and/or sulfuric acid.

The metal substrate may optionally be pretreated with any suitable solution known in the art, such as a metal phosphate solution, an aqueous solution containing at least one Group IIIB or IVB metal, an organophosphate solution, an organophosphonate solution, and combinations thereof. The pretreatment solutions may be essentially free of environmentally detrimental heavy metals such as chromium and nickel. Suitable phosphate conversion coating compositions may be any of those known in the art that are free of heavy metals. Examples include zinc phosphate, which is used most often, iron phosphate, manganese phosphate, calcium phosphate, magnesium phosphate, cobalt phosphate, zinc-iron phosphate, zinc-manganese phosphate, zinc-calcium phosphate, and layers of other types, which may contain one or more multivalent cations. Phosphating compositions are known to those skilled in the art and are described in U.S. Pat. Nos. 4,941,930, 5,238,506, and 5,653,790.

The IIIB or IVB transition metals and rare earth metals referred to herein are those elements included in such groups in the CAS Periodic Table of the Elements as is shown, for example, in the Handbook of Chemistry and Physics, 63^{rd} Edition (1983).

Typical group IIIB and IVB transition metal compounds and rare earth metal compounds are compounds of zirconium, titanium, hafnium, yttrium and cerium and mixtures thereof. Typical zirconium compounds may be selected from hexafluorozirconic acid, alkali metal and ammonium salts thereof, ammonium zirconium carbonate, zirconyl nitrate, zirconium carboxylates and zirconium hydroxy carboxylates such as hydrofluorozirconic acid, zirconium acetate, zirconium oxalate, ammonium zirconium glycolate, ammonium zirconium lactate, ammonium zirconium citrate, and mixtures thereof. Hexafluorozirconic acid is used most often. An example of a titanium compound is fluorotitanic acid and its salts. An example of a hafnium compound is hafnium nitrate. An example of an yttrium compound is yttrium nitrate. An example of a cerium compound is cerous nitrate.

Typical compositions to be used in the pretreatment step include non-conductive organophosphate and organophosphonate pretreatment compositions such as those disclosed in U.S. Pat. Nos. 5,294,265 and 5,306,526. Such organophosphate or organophosphonate pretreatments are available commercially from PPG Industries, Inc. under the name NUPAL.

In the aerospace industry, anodized surface treatments as well as chromium-based conversion coatings/pretreatments are often used on aluminum alloy substrates. Examples of anodized surface treatments would be chromic acid anodizing, phosphoric acid anodizing, boric acid-sulfuric acid anodizing, tartaric acid anodizing, sulfuric acid anodizing. Chromium based conversion coatings include hexavalent chromium types, such as BONDERITE M-CR1200 from Henkel, and trivalent chromium types, such as BONDERITE M-CR T5900 from Henkel.

The multi-layer coating composite may comprise a primer or a topcoat layer. It is understood that suitable topcoat layers include any of those known in the art, and each independently may be waterborne, solventborne, in solid particulate form (i.e., a powder coating composition), or in the form of a powder slurry. The topcoat typically includes a film-forming polymer, crosslinking material and, if a colored base coat or monocoat, one or more pigments. According to the present disclosure, the primer layer may be disposed between the coating layer and the base coat layer. According to the present disclosure, one or more of the topcoat layers may be applied onto a substantially uncured underlying layer. For example, a clear coat layer may be applied onto at least a portion of a substantially uncured basecoat layer (wet-on-wet), and both layers may be simultaneously cured in a downstream process.

Moreover, the topcoat layers may be applied directly onto the coating layer. In other words, the substrate lacks a primer layer. For example, a basecoat layer may be applied directly onto at least a portion of the coating layer.

It will also be understood that the topcoat layers may be applied onto an underlying layer despite the fact that the underlying layer has not been fully cured. For example, a clearcoat layer may be applied onto a basecoat layer even though the basecoat layer has not been subjected to a curing step. Both layers may then be cured during a subsequent curing step thereby eliminating the need to cure the basecoat layer and the clearcoat layer separately.

According to the present disclosure, additional ingredients such as colorants and fillers may be present in the various coating compositions from which the topcoat layers result. Any suitable colorants and fillers may be used. For example, the colorant may be added to the coating in any suitable form, such as discrete particles, dispersions, solutions and/or flakes. A single colorant or a mixture of two or more colorants can be used in the coatings of the present disclosure. It should be noted that, in general, the colorant can be present in a layer of the multi-layer composite in any amount sufficient to impart the desired property, visual and/or color effect.

Example colorants include pigments, dyes and tints, such as those used in the paint industry and/or listed in the Dry Color Manufacturers Association (DCMA), as well as special effect compositions. A colorant may include, for example, a finely divided solid powder that is insoluble but wettable under the conditions of use. A colorant may be organic or inorganic and may be agglomerated or non-agglomerated. Colorants may be incorporated into the coatings by grinding or simple mixing. Colorants may be incorporated by grinding into the coating by use of a grind vehicle, such as an acrylic grind vehicle, the use of which will be familiar to one skilled in the art.

The coating compositions of the present disclosure may be used as corrosion resistant primers. As indicated, the present disclosure may be directed to metal substrate primer coating compositions, such as “etch primers.” As used herein, the term “primer coating composition” refers to coating compositions from which an undercoating may be deposited onto a substrate. In some industries or on certain substrates, the primer is applied to prepare the surface for application of a protective or decorative coating system. In other industries or substrates, another coating layer is not applied on top of the primer. For example, substrate surfaces that have limited or no external exposure might have a primer with no other layer on top. As used herein, the term “etch primer” refers to primer coating compositions that include an adhesion promoting component, such as a free acid as described in more detail above.

Suitable topcoats (base coats, clear coats, pigmented monocoats, and color-plus-clear composite compositions) include any of those known in the art, and each may be waterborne, solventborne or powdered. The topcoat typically includes a film-forming resin, crosslinking material and pigment (in a colored base coat or monocoat), such as film-forming binder comprising a fluoropolymer and/or a polyurethane. Examples of suitable base coat compositions include waterborne base coats such as are disclosed in U.S. Pat. Nos. 4,403,003; 4,147,679; and 5,071,904. Suitable clear coat compositions include those disclosed in U.S. Pat. Nos. 4,650,718; 5,814,410; 5,891,981; and WO 98/14379.

The coating composition may also optionally be formulated as a sealant composition.

For purposes of this detailed description, it is to be understood that the disclosure may assume alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

As used herein, “including,” “containing” and like terms are understood in the context of this application to be synonymous with “comprising” and are therefore open-ended and do not exclude the presence of additional undescribed or unrecited elements, materials, ingredients or method steps. Nevertheless, they also include the more restrictive terms “consisting of” and “consisting essentially of. As used herein, “consisting of” is understood in the context of this application to exclude the presence of any unspecified element, ingredient or method step. As used herein, “consisting essentially of” is understood in the context of this application to include the specified elements, materials, ingredients or method steps “and those that do not materially affect the basic and novel characteristic(s)” of what is being described. Open-ended terms include closed terms, e.g., “comprising” includes “consisting of” and “consisting essentially of.”

In this application, the use of the singular includes the plural and plural encompasses singular, unless specifically stated otherwise. For example, although reference is made herein to “a” film-forming binder, “a” rare earth metal oxide, “a” magnesium oxide particle, “an” organic resin component, and “a” curing agent, a combination (i.e., a plurality) of these components may be used. In addition, in this application, the use of “or” means “and/or” unless specifically stated otherwise, even though “and/or” may be explicitly used in certain instances.

Whereas specific aspects of the disclosure have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosure which is to be given the full breadth of the claims appended and any and all equivalents thereof.

### ASPECTS

Aspect 1. A coating composition comprising (a) a film-forming binder; (b) rare earth metal oxide particles; and (c) magnesium oxide particles having a particle size measured along a shortest axis of the particle of at least 1 micron as measured by TEM.

Aspect 2. The coating composition of aspect 1, further comprising (d) magnesium oxide particles having a particle size measured along a shortest axis of the particle of no more than 500 nm.

Aspect 3. The coating composition of aspect 2, wherein the magnesium oxide particles having a particle size measured along a shortest axis of the particle of at least 1 micron comprise a first population of magnesium oxide particles, the magnesium oxide particles having a particle size measured along a shortest axis of the particle of no more than 500 nm comprise a second population of magnesium oxide particles, and the particle size measured along the shortest axis of the first population of magnesium oxide particles is at least 2 times as large as the particle size measured along the shortest axis of the second population of magnesium oxide particles, such as at least 3 times as large, such as at least 5 times as large, such as at least 10 times as large, such as at least 50 times as large, such as at least 100 times as large, such as at least 200 times as large, such as at least 250 times as large.

Aspect 4. The coating composition of aspect 2 or 3, wherein a weight ratio of the magnesium oxide particles have a particle size measured along a shortest axis of the particle of no more than 500 nm to the magnesium oxide particles having a particle size measured along a shortest axis of the particle of at least 1 micron is from 1:3 to 3:1, such as 1:3 to 2:1, such as 1:3 to 1.2:1, such as 1:3 to 1:1, such as 1:2 to 3:1, such as 1:2 to 2:1, such as 1:2 to 1.2:1, such as 1:2 to 1:1, such as 1:1.2 to 3:1, such as 1:1.2 to 2:1, such as 1:1 to 3:1, such as 1:1 to 2:1, such as 1:1 to 1.2:1, such as 1.2:1 to 3:1, such as 1.2:1 to 2:1, such as 2:1 to 3:1.

Aspect 5. The coating composition of any of the preceding aspects, wherein the coating composition comprises 1% to 70% by weight of magnesium oxide particles (c) and (d), such as 1% to 50% by weight, such as 1% to 40% by weight, such as 1% to 30% by weight, such as 1% to 25% by weight, such as 1% to 20% by weight, such as 2% to 70% by weight, such as 2% to 50% by weight, such as 2% to 40% by weight, such as 2% to 30% by weight, such as 2% to 25% by weight, such as 2% to 20% by weight, such as 5% to 70% by weight, such as 5% to 50% by weight, such as 5% to 40% by weight, such as 5% to 30% by weight, such as 5% to 25% by weight, such as 5% to 20% by weight, such as 10% to 70% by weight, such as 10% to 50% by weight, such as 10% to 40% by weight, such as 10% to 30% by weight, such as 10% to 25% by weight, such as 10% to 20% by weight, such as 15% to 70% by weight, such as 15% to 50% by weight, such as 15% to 40% by weight, such as 15% to 30% by weight, such as 15% to 25% by weight, such as 15% to 20% by weight, such as 20% to 70% by weight, such as 20% to 50% by weight, such as 20% to 40% by weight, such as 20% to 30% by weight, such as 20% to 25% by weight, based on the total solids weight of the coating composition.

Aspect 6. The coating composition of any of the preceding aspects 2-5, wherein the coating composition comprises 1% to 50% by weight of the magnesium oxide particles have a particle size measured along a shortest axis of the particle of no more than 500 nm, such as 1% to 40% by weight, such as 1% to 30% by weight, such as 1% to 25% by weight, such as 1% to 20% by weight, such as 1% to 15% by weight, such as 2% to 50% by weight, such as 2% to 40% by weight, such as 2% to 30% by weight, such as 2% to 25% by weight, such as 2% to 20% by weight, such as 2% to 15% by weight, such as 3% to 50% by weight, such as 3% to 40% by weight, such as 3% to 30% by weight, such as 3% to 25% by weight, such as 3% to 20% by weight, such as 3% to 15% by weight, such as 5% to 50% by weight, such as 5% to 40% by weight, such as 5% to 30% by weight, such as 5% to 25% by weight, such as 5% to 20% by weight, such as 5% to 15% by weight, such as 8% to 50% by weight, such as 8% to 40% by weight, such as 8% to 30% by weight, such as 8% to 25% by weight, such as 8% to 20% by weight, such as 8% to 15% by weight, such as 10% to 50% by weight, such as 10% to 40% by weight, such as 10% to 30% by weight, such as 10% to 25% by weight, such as 10% to 20% by weight, such as 10% to 15% by weight, and
the coating composition comprises 1% to 70% by weight of the magnesium oxide particles have a particle size measured along a shortest axis of the particle of at least 1 micron, such as at least 1% to 50% by weight, such as 1% to 40% by weight, such as 1% to 30% by weight, such as 1% to 25% by weight, such as 1% to 20% by weight, such as 1% to 15% by weight, such as 2% to 70% by weight, such as 2% to 50% by weight, such as 2% to 40% by weight, such as 2% to 30% by weight, such as 2% to 25% by weight, such as 2% to 20% by weight, such as 2% to 15% by weight, such as 3% to 70% by weight, such as 3% to 50% by weight, such as 3% to 40% by weight, such as 3% to 30% by weight, such as 3% to 25% by weight, such as 3% to 20% by weight, such as 3% to 15% by weight, such as 5% to 70% by weight, such as 5% to 50% by weight, such as 5% to 40% by weight, such as 5% to 30% by weight, such as 5% to 25% by weight, such as 5% to 20% by weight, such as 5% to 15% by weight, such as 8% to 50% by weight, such as 8% to 40% by weight, such as 8% to 30% by weight, such as 8% to 25% by weight, such as 8% to 20% by weight, such as 8% to 15% by weight, such as 10% to 50% by weight, such as 10% to 40% by weight, such as 10% to 30% by weight, such as 10% to 25% by weight, such as 10% to 20% by weight, such as 10% to 15% by weight, based on the total solids weight of the coating composition.

Aspect 7. The coating composition of any of the preceding aspects, wherein the coating composition comprises 1% to 50% by weight of rare earth metal oxide particles, such as 1% to 40% by weight, such as 1% to 30% by weight, such as 1% to 20% by weight, such as 1% to 15% by weight, such as 1% to 10% by weight, such as 1% to 6% by weight, such as 1% to 3% by weight, such as 2% to 50% by weight, such as 2% to 40% by weight, such as 2% to 30% by weight, such as 2% to 20% by weight, such as 2% to 15% by weight, such as 2% to 10% by weight, such as 2% to 6% by weight, such as 2% to 3% by weight, such as such as 3% to 50% by weight, such as 3% to 40% by weight, such as 3% to 30% by weight, such as 3% to 20% by weight, such as 3% to 15% by weight, such as 3% to 10% by weight, such as 3% to 6% by weight, such as 4% to 50% by weight, such as 4% to 40% by weight, such as 4% to 30% by weight, such as 4% to 20% by weight, such as 4% to 15% by weight, such as 4% to 10% by weight, such as 4% to 6% by weight, such as 5% to 50% by weight, such as 5% to 40% by weight, such as 5% to 30% by weight, such as 5% to 20% by weight, such as 5% to 15% by weight, such as 5% to 10% by weight, such as 5% to 6% by weight, such as 8% to 50% by weight, such as 8% to 40% by weight, such as 8% to 30% by weight, such as 8% to 20% by weight, such as 8% to 15% by weight, such as 8% to 10% by weight, such as 10% to 50% by weight, such as 10% to 40% by weight, such as 10% to 30% by weight, such as 10% to 20% by weight, such as 10% to 15% by weight, based on the total solids weight of the coating composition.

Aspect 8. The coating composition of any of the preceding aspects, wherein rare earth metal oxide particles comprise yttrium oxide, praseodymium oxide, cerium oxide, or any combination thereof.

Aspect 9. The coating composition of any of the preceding aspects, wherein a weight ratio of magnesium oxide particles to rare earth metal oxide particles is from 1:1 to 15:1, such as 1:1 to 10:1, such as 1:1 to 8:1, such as 1:1 to 6:1, such as 1:1 to 5:1, such as 1:1 to 4:1, such as 1:1 to 3:1, such as 1:1 to 2:1, such as 1.5:1 to 15:1, such as 1.5:1 to 10:1, such as 1.5:1 to 8:1, such as 1.5:1 to 6:1, such as 1.5:1 to 5:1, such as 1.5:1 to 4:1, such as 1.5:1 to 3:1, such as 1.5:1 to 2:1, such as 3:1 to 15:1, such as 3:1 to 10:1, such as 3:1 to 8:1, such as 3:1 to 6:1, such as 3:1 to 5:1, such as 3:1 to 4:1, such as 5:1 to 15:1, such as 5:1 to 10:1, such as 5:1 to 8:1, such as 5:1 to 6:1, such as 6:1 to 15:1, such as 6:1 to 10:1, such as 6:1 to 8:1, such as 8:1 to 15:1, such as 8:1 to 10:1, such as 10:1 to 15:1.

Aspect 10. The coating composition of any of the preceding aspects, wherein the film-forming binder component comprises a thermoplastic film-forming binder comprising (a) an organic resin component.

Aspect 11. The coating composition of any of aspects 1-9, wherein the film-forming binder component comprises a thermosetting film-forming binder comprising (a) an organic resin component; and (b) a curing agent.

Aspect 12. The coating composition of aspect 10 or 11, wherein the organic resin component (a) comprises one or more of acrylic polymers, polyesters, polyurethanes, polyamides, polyethers, polythioethers, polythioesters, polythiols, polyenes, polyols, polysilanes, polysiloxanes, fluoropolymers, polycarbonates, and epoxy resins; and/or wherein the curing agent comprises aminoplasts, polyisocyanates, polyepoxides, beta-hydroxyalkylamides, polyacids, organometallic acid-functional materials, polyamines, polyamides, polysulfides, polythiols, polyenes, polyols, polysilanes, and any combination thereof.

Aspect 13. The coating composition of any of aspects 10-12, wherein the organic resin component comprises a polymer having epoxide functional groups, and the curing agent comprises a crosslinker comprising amino functional groups.

Aspect 14. The coating composition of any of aspect 11 or 12, wherein the organic resin component comprises a polymer having hydroxyl functional groups, and the curing agent comprises a crosslinker comprising isocyanato functional groups.

Aspect 15. The coating composition of any of aspects 10-14, wherein the curing agent comprises high molecular weight volatile groups.

Aspect 16. The coating composition of any of the preceding aspects, wherein the coating composition further comprises an organic solvent and is a solventborne coating composition.

Aspect 17. The coating composition of any of the preceding aspects, wherein the coating composition further comprises calcium sulfate.

Aspect 18. The coating composition of any of the preceding aspects, wherein the coating composition is substantially free, essentially free, or completely free of an inorganic corrosion inhibitor.

Aspect 19. The coating composition of any of the preceding aspects, wherein the coating composition is substantially free, essentially free, or completely free of chromium-containing material.

Aspect 20. The coating composition of any of the preceding aspects, wherein the coating composition is substantially free, essentially free, or completely free of amino acid corrosion inhibitors, and/or the coating composition is substantially free, essentially free, or completely free of lithium-containing corrosion inhibitors.

Aspect 21. The coating composition of any of the preceding aspects, wherein the film-forming binder does not include organic resin comprising self-crosslinking groups.

Aspect 22. The coating composition of any of the preceding aspects, wherein the coating composition is formulated as a sealant composition.

Aspect 23. A substrate comprising a coating formed from the composition of any of aspects 1-22 on at least a portion of a surface of the substrate.

Aspect 24. A substrate comprising a coating on at least a portion of a surface of the substrate comprising: a film-forming binder; magnesium oxide particles having a particle size measured along a shortest axis of the particle of at least 1 micron; and rare earth metal oxide particles.

Aspect 25. The coated metal substrate of aspect 23 or 24, wherein the coating is adhered directly to the surface of the substrate without an intermediate coating layer between the surface of the substrate and the coating.

Aspect 26. The coated metal substrate of any of aspects 23-25, wherein the substrate comprises aluminum or an aluminum alloy.

Aspect 27. The coated metal substrate of any of aspects 23-26, wherein the substrate is clad or not clad, and if clad, the clad layer may be the same or different as the substrate.

Aspect 28. The coated metal substrate of any of aspects 23-27, wherein the substrate is a clad aluminum alloy and wherein the clad layer is aluminum.

Aspect 29. The coated metal substrate of any of aspects 23-28, wherein the substrate is an aircraft part.

Aspect 30. A multilayer coated substrate comprising: (a) a first coating layer on at least a portion of a surface of the substrate; and (b) a second coating layer on at least a portion of the first coating, wherein the first coating layer, the second coating layer or both layers comprise a film-forming binder, magnesium oxide particles having a particle size measured along a shortest axis of the particle of at least 1 micron, and rare earth metal oxide particles.

Aspect 31. The multilayer coated substrate of aspect 30, wherein the first coating layer, the second coating layer or both layers is formed from the coating composition of any of the preceding aspects 1-22.

Aspect 32. The multilayer coated substrate of aspect 30 or 31, wherein the first coating layer is adhered directly to the substrate without an intermediate coating layer between the surface of the substrate and the first coating layer.

Aspect 33. The multilayer coated substrate of aspects 30-32, wherein the substrate comprises aluminum and/or an aluminum alloy.

Aspect 34. The multilayer coated substrate of any of aspects 30-33, wherein the substrate is clad or not clad, and if clad, the clad layer may comprise the same or a different material as the metal substrate.

Aspect 35. The multilayer coated substrate of any of aspects 30-34, wherein the substrate is a clad aluminum alloy and wherein the clad layer is aluminum.

Aspect 36. The multilayer coated substrate of any of aspects 30-35, wherein the substrate is an aircraft part.

Aspect 37. The multilayer coated substrate of any of aspects 30-36, wherein the film-forming binder of the second coating layer comprises a fluoropolymer and/or a polyurethane.

Aspect 38. The multilayer coated substrate of any of aspects 30-37, wherein the first coating layer comprises a primer, and the second coating layer comprises a topcoat.

Aspect 39. The multilayer coated substrate of any of aspects 30-38, wherein the first coating layer comprises a pigmented primer, and the second coating layer comprises a clearcoat.

Aspect 40. The multilayer coated substrate of any of aspects 30-39, wherein the film-forming binder of the first coating layer comprises epoxy and amine and the film-forming binder of the second coating layer comprises polyurethane or epoxy.

Aspect 41. A method for coating a substrate comprising applying the coating composition of any of aspects 1-22 to at least a portion of a surface of the substrate.

Aspect 42. The method of aspect 41, wherein the method comprises applying the coating composition by dipping, immersion, spraying, intermittent spraying, dipping followed by spraying, spraying followed by dipping, brushing, roll-coating, or any combination thereof.

Aspect 43. The method of aspect 41 or 42, wherein the method further comprises at least partially curing the applied coating composition to form an at least partially cured coating on the surface of the substrate.

Aspect 44. A coating layer formed by at least partially curing a coating applied from the coating composition of any of aspects 1-22.

Illustrating the disclosure are the following examples, which, however, are not to be considered as limiting the disclosure to their details. Unless otherwise indicated, all parts and percentages in the following examples, as well as throughout the specification, are by weight.

### EXAMPLES

Table 1 identifies the rare earth metal oxide, magnesium oxide, and calcium sulfate raw materials used to make coating compositions in the subsequent Examples.

TABLE 1
Raw Materials and Suppliers

| Raw Material | Description | Supplier |
|---|---|---|
| Nano magnesium | Nano particle size MgO, | US Research |
| oxide | with 20 nm average | Nanomaterials, |
| | particle size | Inc., TX |
| Maglite Y | Micron particle size MgO | The Hallstar |
| | with <10 micron average | Company, IL |
| | particle size, 55 m²/g | |
| | surface area | |
| Yttrium | Yttrium oxide | Treibacher Industrie |
| oxide | | AG, Austria |
| Praseodymium | Praseodymium | Treibacher Industrie |
| oxide | oxide | AG, Austria |
| Gypsum | Calcium sulfate | U.S. Gypsum, Chicago, |
| | dihydrate | Illinois |

Epoxy-amine 2K (two-package) coating compositions were prepared from the components provided in the following tables:

TABLE 2
Coatings composition of control examples 1, 2, and 3

| | Control 1 | Control 2 | Control 3 |
|---|---|---|---|
| Raw Materials | Weight (grams) | Weight (grams) | Weight (grams) |
| Base Component | | | |
| Epoxy Coating Binder | 31.54 | 31.54 | 31.54 |
| Titanium Dioxide | 7.51 | 22.59 | 11.07 |
| Maglite Y | 0.00 | 6.63 | 6.63 |
| Nano MgO | 0.00 | 6.87 | 6.87 |
| Yttrium oxide | 8.60 | 0.00 | 0.00 |
| Gypsum | 20.24 | 0.00 | 15.34 |
| Talc | 0.00 | 3.83 | 0.00 |
| Organic Solvent | 32.11 | 28.54 | 28.55 |
| Activator Component | | | |
| Amino Curing Agent | 21.11 | 21.11 | 21.11 |
| Total | 121.11 | 121.11 | 121.11 |

TABLE 3
Coatings composition for examples 1, 2, 3, and 4

| | Example 1 | Example 2 | Example 3 | Example 4 |
|---|---|---|---|---|
| | Weight | Weight | Weight | Weight |
| Raw Materials | (grams) | (grams) | (grams) | (grams) |
| Base Component | | | | |
| Epoxy Coating | 31.54 | 31.54 | 31.54 | 31.54 |
| Binder | | | | |
| Titanium Dioxide | 7.51 | 7.51 | 7.51 | 7.51 |
| Maglite Y | 6.63 | 13.50 | 11.50 | 4.70 |
| Nano MgO | 6.87 | 0.00 | 2.00 | 8.80 |
| Yttrium oxide | 3.56 | 3.56 | 3.56 | 3.56 |
| Gypsum | 15.35 | 15.35 | 15.35 | 15.35 |
| Organic Solvent | 28.54 | 28.54 | 28.54 | 28.54 |
| Activator Component | | | | |
| Amino Curing Agent | 21.11 | 21.11 | 21.11 | 21.11 |
| Total | 121.11 | 121.11 | 121.11 | 121.11 |

TABLE 4
Coatings composition for examples 5 and 6

| | Example 5 | Example 6 |
|---|---|---|
| Raw Materials | Weight (grams) | Weight (grams) |
| Base Component | | |
| Epoxy Coating Binder | 31.54 | 31.54 |
| Titanium Dioxide | 20.81 | 19.20 |
| Maglite Y | 6.63 | 6.63 |
| Nano MgO | 6.87 | 6.87 |
| Yttrium oxide | 1.77 | 3.56 |
| Gypsum | 0.00 | 0.00 |
| Talc | 3.83 | 3.83 |
| Organic Solvent | 28.55 | 28.37 |
| Activator Component | | |
| Amino Curing Agent | 21.11 | 21.11 |
| Total | 121.11 | 121.11 |

TABLE 5
Coatings composition for example 7

| | Example 7 |
|---|---|
| Raw Materials | Weight (grams) |
| Base Component | |
| Epoxy Coating Binder | 31.54 |
| Titanium Dioxide | 19.20 |
| Maglite Y | 6.63 |
| Nano MgO | 6.87 |
| Praseodymium oxide | 3.56 |
| Gypsum | 0.00 |
| Talc | 3.83 |
| Organic Solvent | 28.37 |
| Activator Component | |
| Amino Curing Agent | 21.11 |
| Total | 121.11 |

TABLE 6
Coatings composition for example 8

| | Example 8 |
|---|---|
| Raw Materials | Weight (grams) |
| Base Component | |
| Epoxy Coating Binder | 31.54 |
| Titanium Dioxide | 19.30 |
| Maglite Y | 6.63 |
| Nano MgO | 6.87 |
| Yttrium oxide | 7.12 |
| Gypsum | 0.00 |
| Talc | 0.00 |
| Organic Solvent | 28.54 |
| Activator Component | |
| Amino Curing Agent | 21.11 |
| Total | 121.11 |

Coating composition preparation: For the base components of Controls 1-3 and Examples 1-8, all materials as listed in Table 2-6 were weighed and placed into glass jars. Dispersing media was then added to each jar at a level equal to approximately 35% of the total weight of the base component materials. The jars were sealed with lids and then placed on a Lau DAS 200 Dispersing Unit (Lau GmbH) with a dispersion time of 3 hours. All final dispersions had Hegman gauge readings greater than 7. Prior to coating application, the corresponding amounts of base component and activator component shown for each example in Table 2-6 were combined, mixed thoroughly and given an induction time between 30 and 60 minutes prior to application.

Control 4 was a commercially available 2K epoxy-amine coating composition with strontium chromate pigment.

A summary of the components of the coating compositions is provided in Table 7 below with the percentages provided on total solids of each respective coating composition:

TABLE 7
Summary of the coating corrosion inhibitors composition

| | Corrosion | | | | Rare |
|---|---|---|---|---|---|
| | Inhibitor | Nano | Micron | | Earth |
| No | Description | MgO % | MgO % | CaSO₄ | Oxide % |
| C1 | Yttrium Oxide/Gypsum | — | — | 30.2 | 12.9 |
| C2 | Nano/micron MgO | 10.3 | 9.9 | — | — |
| C3 | Nano/micron | 10.3 | 9.9 | 22.9 | — |
| | MgO/Gypsum | | | | |
| C4 | SrCrO₄ | — | — | — | — |
| 1 | Yttrium oxide/ | 10.3 | 9.9 | 22.9 | 5.3 |
| | MgO/Gypsum | | | | |
| 2 | Yttrium oxide/ | 0.0 | 20.2 | 22.9 | 5.3 |
| | MgO/Gypsum | | | | |
| 3 | Yttrium oxide/ | 3.0 | 17.2 | 22.9 | 5.3 |
| | MgO/Gypsum | | | | |
| 4 | Yttrium oxide/ | 13.2 | 7.0 | 22.9 | 5.3 |
| | MgO/Gypsum | | | | |
| 5 | Yttrium oxide/MgO | 10.3 | 9.9 | — | 2.7 |
| 6 | Yttrium oxide/MgO | 10.2 | 9.9 | — | 5.3 |
| 7 | Praseodymium | 10.2 | 9.9 | — | 5.3 |
| | oxide/MgO | | | | |
| 8 | Yttrium oxide/MgO | 10.3 | 9.9 | — | 10.6 |

Substrate preparation: The coatings of Controls 1-4 and Examples 1-8 were spray applied onto 2024-T3 aluminum alloy substrate panels after abrading or Alodine 1200s treatment.

For the abraded panels, the substrate panels were cleaned using an acetone wipe followed by wet abrading using Scotch-Brite 7447 pad to produce a water-break free surface. Panels were rinsed thoroughly with water and allowed to dry. A final wipe with methyl ethyl ketone was performed prior to coating application.

For the Alodine treated panels, the substrate panels were cleaned and treated according to MIL-DTL-5541 (Chemical Conversion Coatings on Aluminum and Aluminum Alloys). The coatings were applied within 72 hours of metal substrate treatment.

Coating application: The coatings of Controls 1-4 and Examples 1-8 were spray applied onto 2024-T3 aluminum alloy substrate panels to a dry film thickness of between 0.7 to 1.2 mils using an air atomized spray gun.

Coating curing: All the coated test panels were allowed to age under ambient conditions for a minimum of 7 days.

### Testing Methods

Crosshatch Adhesion Testing: Crosshatch adhesion was determined according to ASTM D3359-17 (Standard Test Methods for Measuring Adhesion by Tape Test), method B. A crosshatch pattern was scribed through the coating down to the substrate. A strip of 1-inch (25.4 mm) wide masking tape (such as 3M 250 or equivalent) was applied onto the scribed coating. The tape was pressed down using two passes of a 4.5-pound rubber covered roller. The tape was then removed in one abrupt motion perpendicular to the panel. The adhesion was rated by a visual examination of the coating at the crosshatch area using the provided rating system. Dry adhesion was tested after fully curing the coating system for 7 or 14 days. Wet adhesion was tested on a fully cured coating system after immersing the test panel in water at 75° F. (23° C.) for 24 hours. Panels were removed from the water, wiped dry with a paper towel, and tested after 5 minutes. The adhesion of the coating systems was rated as follows: 5B: The edges of the cuts are completely smooth and none of the lattice squares are detached; 4B: Small flakes of the coating are detached at the intersections. Less than 5% of the lattice area is affected; 3B: Small flakes of the coating are detached along edges and at intersections of cuts. The area affected is from 5% to 15% of the lattice; 2B: The coating flaked along the edges and on parts of the squares. The area affected is from 15% to 35% of the lattice; 1B: The coating flaked along the edges of cuts in large ribbons and squares have detached. The area affected is from 35% to 65% of the lattice; 0B: Flaking and detachment worse than for Grade 1B.

Pencil Hardness: Pencil hardness was determined in accordance with ASTM D3363-22 (Standard Test Method for Film Hardness by Pencil Test). Hardness of each coating composition was determined relative to a standard set of pencil leads by scratching the leads across the coating at a 45-degree angle for about one-quarter of an inch. The process was repeated until a lead was identified that did not scratch the film. The number of the lead was recorded as the hardness.

MEK Resistance: Solvent resistance was determined in accordance with ASTM D5402-15 (Standard Practice for Assessing the Solvent Resistance of Organic Coatings Using Solvent Rubs) by using a gauze cloth that was saturated with MEK solvent. MEK double rubs were recorded at the point when noticeable scratches were observed. If no noticeable scratches were observed after 200 MEK double rubs, the result was recorded as >200.

Skydrol Resistance: The fully cured coated panels were immersed in the hydraulic fluid Skydrol LD-4 (available from Solutia, Inc.) at room temperature for 30 days. Surfaces of the coatings were checked for paint peeling, blistering or significant color change. Any signs of coating failure were recorded as “fail”; otherwise, it was recorded as “pass”.

Corrosion Resistance: Corrosion resistance was determined according to ASTM B117-19 (Standard Practice for Operating Salt Spray (Fog) Apparatus). Test panels were prepared as described above using at least three abraded aluminum panels or Alodine 1200s treated aluminum panels of approximate 0.032 inch thickness. Two diagonal marks (scribe lines) were machine scribed extending from corner to corner on each panel. Width of scribe lines shall be between 0.031 and 0.064 inch and penetrate through the coating and into the base metal. Test panels were exposed to 5 percent salt spray fog for 3000 to 3050 hours, with painted side up.

The panels were examined for corrosion and blisters according to the following scale:

Scribe Corrosion: Rating is 0 to 100 and number represents percent of scribe area exhibiting visible corrosion. Lower rating number is better.

Shiny/Nature of Scribe: Rating is 0-100 and number represents percent of scribe which is shiny scribe. Higher rating number is better.

Blisters: Total number of blisters adjacent to scribe and away from scribe (i.e., Face) blisters are counted up to 30. Lower rating number is better.

The size of the largest blister adjacent to the scribe is recorded as: 0 No scribe blisters are present; < 1/16″ Largest scribe blister is less than 1/16″ diameter; 1/16″ Largest scribe blister is between 1/16″ and ⅛″ diameter; and >⅛″ Largest scribe blister is greater than ⅛″ diameter.

### Testing Results

TABLE 8
Physical properties of the coatings on abraded aluminum substrate

| | Dry/Wet | Pencil | MEK | Skydrol |
|---|---|---|---|---|
| No. | Adhesion | Hardness | Resistance | LD-4 |
| C1 | 5B/5B | 4H | >200 | Pass |
| C2 | 5B/5B | 4H | >200 | pass |
| C3 | 5B/5B | 4H | >200 | pass |
| C4 | 5B/5B | 4H | >200 | Pass |
| 1 | 5B/5B | 4H | >200 | pass |
| 2 | 5B/5B | 4H | >200 | pass |
| 3 | 5B/5B | 4H | >200 | pass |
| 4 | 5B/5B | 4H | >200 | pass |
| 5 | 5B/5B | 4H | >200 | pass |
| 6 | 5B/5B | 4H | >200 | pass |
| 7 | 5B/5B | 4H | >200 | pass |
| 8 | 5B/5B | 4H | >200 | Pass |

The ratings shown in TABLE 9 were at 3,000 hours of exposure with coatings applied to the Alodine 1200 treated bare aluminum substrate.

TABLE 9
Corrosion results on Alodine 1200 after
3,000 hours of neutral salt spray

| | Scribe | Scribe | Scribe | Face | Blister |
|---|---|---|---|---|---|
| No. | Corr. | Shine | Blisters | Blisters | size |
| C1 | 100 | 0 | 2 | 0 | < 1/16″ |
| C2 | 34 | 2 | 0 | 1 | < 1/16″ |
| C3 | 95 | 2 | 0 | 15 | < 1/16″ |
| C4 | 3 | 97 | 0 | 0 | 0 |
| 1 | 10 | 95 | 0 | 0 | 0 |
| 2 | 20 | 90 | 0 | 10 | < 1/16″ |
| 3 | 20 | 80 | 0 | 2 | < 1/16″ |
| 4 | 20 | 80 | 0 | 2 | < 1/16″ |
| 5 | 13 | 60 | 0 | 0 | 0 |
| 6 | 23 | 64 | 0 | 0 | 0 |
| 7 | 13 | 18 | 0 | 0 | 0 |
| 8 | 24 | 20 | 0 | 0 | 0 |

The ratings shown in TABLE 10 were at 3,000 hours of exposure with coatings applied to the Scotch-Brite abraded bare aluminum substrate.

TABLE 10
Corrosion results on abraded aluminum
after 3,000 hours of neutral salt spray

| | Scribe | Scribe | Scribe | Face | Blister |
|---|---|---|---|---|---|
| No. | Corr. % | Shine % | Blisters | Blisters | size |
| Control 1 | 100 | 0 | 4 | 21 | <0.16″ |
| Control 2 | 100 | 5 | 0 | 12 | <0.16″ |
| Control 3 | 100 | 2 | 0 | 15 | <0.16″ |
| 5 | 25 | 45 | 0 | 0 | 0 |
| 6 | 27 | 36 | 0 | 4 | <0.16″ |
| 7 | 91 | 9 | 0 | 6 | <0.16″ |
| 8 | 75 | 13 | 0 | 0 | 0 |

These results demonstrate that the coating compositions including magnesium oxide and a rare earth metal oxide (yttrium oxide or praseodymium oxide) provided improved corrosion resistance over just magnesium oxide (Control Examples 2 and 3) or just a rare earth metal oxide (Control Example 1) and provide comparable corrosion performance to a chromium-containing coating composition (Control Example 4). The improvement was particularly pronounced in Example 1 over Alodine 1200 treated aluminum substrate where the coating composition included micron and nano-sized magnesium oxide with yttrium oxide and gypsum.

It will be appreciated by skilled artisans that numerous modifications and variations are possible in light of the above disclosure without departing from the broad inventive concepts described and exemplified herein. Accordingly, it is therefore to be understood that the foregoing disclosure is merely illustrative of various exemplary aspects of this application and that numerous modifications and variations can be readily made by skilled artisans which are within the spirit and scope of this application and the accompanying claims.

1. A coating composition comprising:
(a) a film-forming binder;
(b) rare earth metal oxide particles; and
(c) magnesium oxide particles having a particle size measured along a shortest axis of the particle of at least 1 micron as measured by TEM.

2. The coating composition of claim 1, further comprising (d) magnesium oxide particles having a particle size measured along a shortest axis of the particle of no more than 500 nm as measured by TEM.

3. The coating composition of claim 2, wherein the particle size of magnesium oxide particles (c) is at least 2 times as large as the particle size of magnesium oxide particles (d), and/or wherein the particle size is measured along the shortest axis of the magnesium oxide particles by TEM, and/or wherein a weight ratio of the magnesium oxide particles (c) to the magnesium oxide particles (d) is 1:3 to 3:1.

4. The coating composition of claim 2, wherein the coating composition comprises 1% to 50% by weight of the magnesium oxide particles (c), the coating composition comprises 1% to 70% by weight of the magnesium oxide particles (d), and the coating composition comprises 1% to 50% by weight of rare earth metal oxide particles, based on the total solids weight of the coating composition.

5. The coating composition of claim 1, wherein rare earth metal oxide particles comprise yttrium oxide, praseodymium oxide, cerium oxide, or any combination thereof.

6. The coating composition of claim 1, wherein a weight ratio of total magnesium oxide particles to rare earth metal oxide particles is from 1:1 to 15:1.

7. The coating composition of claim 1, wherein the film-forming binder component comprises a thermosetting film-forming binder comprising (a) an organic resin component comprising a polymer having epoxide functional groups; and (b) a curing agent comprising a crosslinker comprising amino functional groups.

8. The coating composition of claim 1, wherein the coating composition further comprises an organic solvent and is a solventborne coating composition.

9. The coating composition of claim 1, wherein the coating composition further comprises calcium sulfate.

10. The coating composition of claim 1, wherein the coating composition is substantially free, essentially free, or completely free of chromium-containing material.

11. The coating composition of claim 1, wherein the coating composition is substantially free of amino acid corrosion inhibitors, and the coating composition is substantially free of lithium-containing corrosion inhibitors.

12. The coating composition of claim 1, wherein the coating composition is formulated as a sealant composition.

13. A substrate comprising a coating formed from the composition of claim 1 on at least a portion of a surface of the substrate.

14. The substrate of claim 13, wherein the coating is adhered directly to the surface of the substrate without an intermediate coating layer between the surface and the coating.

15. The substrate of claim 13, wherein the substrate comprises aluminum or an aluminum alloy, such as a clad aluminum alloy wherein the clad layer comprises aluminum.

16. The substrate of claim 13, wherein the substrate is an aircraft part.

17. A multilayer coated metal substrate comprising:
(a) a first coating layer on at least a portion of a surface of the substrate; and
(c) a second coating layer on at least a portion of the first coating,
wherein the first coating layer, the second coating layer or both the first coating layer and the second coating layer comprise a coating formed from the coating composition of claim 1.

18. The multilayer coated metal substrate of claim 17, wherein the first coating layer is a primer, and the second coating layer is a topcoat.

19. A method for coating a substrate comprising applying the coating composition of claim 1 to at least a portion of a surface of the substrate.

20. A coating layer formed by at least partially curing a coating applied from the coating composition of claim 1.
